(19) United States
(12) Patent Application Publication
(10) Pub. No.: US 2022/0364001 A1
(43) Pub. Date: Nov. 17, 2022

(54) PROCESSES FOR REFINING BIOCOMPONENT FEEDSTOCK AND MINERAL HYDROCARBON FEEDSTOCK AND APPARATUS THEREOF

(71) Applicant: ExxonMobil Technology and Engineering Company, Annandale, NJ (US)

(72) Inventors: Dario Campani, Novara (IT); Matthew Bennett, Hampshire (GB); William J. Novak, Bedminster, NJ (US); Himanshu Gupta, Lebanon, NJ (US); Nick Studdert-Kennedy, Southampton (GB)

(21) Appl. No.: 17/597,308

(22) PCT Filed: Aug. 26, 2020
(86) PCT No.: PCT/US2020/047959

§ 371 Date: Jan. 3, 2022

Related U.S. Application Data
(60) Provisional application No. 62/897,547, filed on Sep. 9, 2019.

(51) Int. Cl. C10G 65/14; C10G 67/00

(52) U.S. Cl. CPC C10G 65/14; C10G 67/00; C10G 2300/1011; C10G 2300/202; C10G 2300/4006; C10G 2300/4012; C10G 2300/4018

(57) ABSTRACT

The present disclosure provides processes for refining hydrocarbon feedstocks and apparatus thereof. In at least one embodiment, a process includes hydroprocessing a mineral hydrocarbon feedstock in the presence of a first catalyst in a first reactor, and removing a first reactor effluent from the first reactor. The process includes hydroprocessing a biocomponent feedstock in the presence of a second catalyst in a second reactor, and removing a second reactor effluent from the second reactor. The process includes mixing the first reactor effluent and the second reactor effluent to form a mixture. The process includes introducing the mixture to a separation unit to form a fuel product. In at least one embodiment, an apparatus includes a first hydroprocess reactor. The apparatus includes a second hydroprocess reactor coupled with the first hydroprocess reactor. The apparatus includes a separation unit coupled with the second hydroprocess reactor.

### FIELD OF THE INVENTION

The present disclosure provides processes for hydroprocessing hydrocarbon feedstocks and apparatus thereof.

### BACKGROUND OF THE INVENTION

The oil and gas industry is continually looking for ways to provide fuel from renewable sources. Hydroprocessing of biocomponents (either alone or blended with mineral oil feeds) is one way to produce fuels with bio content. Typically, when processed together, biocomponent feedstocks and mineral hydrocarbon feedstocks are mixed and hydroprocessed by coprocessing the mixture in a single reactor. However, the differences in chemical composition between renewable carbon sources and mineral sources pose some difficulties for refinery processing. For example, typical biologically-derived sources for fuels have an oxygen content of 1 wt % or more, sometimes 10 wt % or more, which can promote corrosion of a reactor. Conventional hydroprocessing methods can remove oxygen from a feedstock, but the by-products from deoxygenation can lead to catalyst poisoning and/or contaminant build-up in a reaction system.

In addition, refining biofuels is an exothermic process resulting in high heat release in the reactor. However, if biocomponent feedstocks and mineral hydrocarbon feedstocks are coprocessed in the same reactor, the feedstock mixture is introduced into the reactor and processed at a high temperature in order to sufficiently desulfurize the mineral hydrocarbon feedstock. The subsequent heat release at an already high temperature during hydroprocessing in the reactor causes a very high outlet temperature of the reactor such that the metallurgy of the reactor outlet might not be suitable for such high temperature. Furthermore, because of the exothermic heat release, coprocessing biocomponent feedstocks and mineral hydrocarbon feedstocks in the same reactor can limit on the amount of biocomponent feedstock that can be coprocessed or can constrain the amount of mineral feed that can be processed for a certain amount of biocomponent. Furthermore, hydroprocessing biocomponent feedstock or a mineral hydrocarbon feedstock separately in two standalone reactors involves introducing excess hydrogen to each reactor, much of which is not reacted in the process and is instead burned off.

There is a need for new and improved processes for refining renewable and fossil feedstocks and apparatus thereof.

References for citing in an Information Disclosure Statement (37 C.F.R. 1.97(h)): U.S. Patent Publication Nos. 2019/0016980; 2017/0283710; U.S. Pat. Nos. 10,000,712; 10,047,299; 10,196,571.

### SUMMARY OF THE INVENTION

The present disclosure provides processes for refining hydrocarbon feedstocks and apparatus thereof.

In at least one embodiment, a process includes hydroprocessing a mineral hydrocarbon feedstock in the presence of a first catalyst in a first reactor and removing a first reactor effluent from the first reactor. The process includes hydroprocessing a biocomponent feedstock in the presence of a second catalyst in a second reactor and removing a second reactor effluent from the second reactor. The process includes mixing the first reactor effluent and the second reactor effluent to form a mixture. The process includes introducing the mixture to a separation unit to form a fuel product.

In at least one embodiment, an apparatus includes a first hydroprocess reactor. The apparatus includes a second hydroprocess reactor coupled with the first hydroprocess reactor. The apparatus includes a separation unit coupled with the first hydroprocess reactor and the second hydroprocess reactor.

In at least one embodiment, an apparatus includes a first hydroprocess reactor and a second hydroprocess reactor. The apparatus includes a first separation unit coupled with and disposed between the first hydroprocess reactor and the second hydroprocess reactor. The apparatus includes a second separation unit coupled with the first hydroprocess reactor and the second hydroprocess reactor.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is to be noted, however, that the appended drawings illustrate only typical examples of this present disclosure and are therefore not to be considered limiting of its scope, for the present disclosure may admit to other equally effective examples.

FIG. 1 is an apparatus configured to form fuel products, according to at least one embodiment.

FIG. 2 is an apparatus configured to form fuel products, according to at least one embodiment.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION OF THE INVENTION

The present disclosure provides processes for refining renewable and fossil feedstocks and apparatuses thereof. In at least one embodiment, a process includes hydroprocessing a mineral hydrocarbon feedstock in the presence of a first catalyst in a first reactor and removing a first reactor effluent from the first reactor. The process includes hydroprocessing a biocomponent feedstock in the presence of a second catalyst in a second reactor and removing a second reactor effluent from the second reactor. The process includes mixing the first reactor effluent and the second reactor effluent to form a mixture. The process includes introducing the mixture to a separation unit to form a fuel product.

In at least one embodiment, a process includes hydroprocessing a mineral hydrocarbon feedstock in the presence of a first catalyst in a first reactor, and removing a first reactor effluent from the first reactor. The process includes introducing the first reactor effluent to a second reactor. The process includes hydroprocessing a biocomponent feedstock and the first reactor effluent in the presence of a second catalyst in the second reactor, and removing a second reactor effluent from the second reactor. The process includes introducing the second reactor effluent to a separation unit to form a fuel product. Introducing the first reactor effluent to the second reactor can provide (1) temperature control (e.g., by dilution) of the contents of the second reactor, and/or (2) a hydrogen source for dewaxing conditions in the second reactor.

In at least one embodiment, a process includes hydroprocessing a mineral hydrocarbon feedstock in the presence of a first catalyst in a first reactor, and removing a first reactor effluent from the first reactor. The process includes introducing at least a portion of the first reactor effluent to a separation unit to form a first separation unit effluent comprising hydrogen and a second separation unit effluent comprising a first hydroprocessed product. The process includes introducing the first separation unit effluent to a second reactor. The process includes hydroprocessing a biocomponent feedstock in the presence of a second catalyst in the second reactor to form a second hydroprocessed product. The process includes dewaxing the second hydroprocessed product in the second reactor to form a dewaxed hydroprocessed product. The process includes removing a second reactor effluent comprising the dewaxed hydroprocessed product from the second reactor. The process includes mixing the first reactor effluent with the second reactor effluent to form a mixture. The process includes introducing the mixture to a separation unit to form a fuel product.

In some embodiments, an apparatus includes a first hydroprocess reactor. The apparatus includes a second hydroprocess reactor coupled with the first hydroprocess reactor. The apparatus includes a separation unit coupled with the first hydroprocess reactor and the second hydroprocess reactor.

In some embodiments, an apparatus includes a first hydroprocess reactor and a second hydroprocess reactor. The apparatus includes a first separation unit coupled with and disposed between the first hydroprocess reactor and the second hydroprocess reactor. The apparatus includes a second separation unit coupled with the first hydroprocess reactor and the second hydroprocess reactor.

Processes and apparatus of the present disclosure can provide a separate hydroprocess reactor for a biocomponent feedstock (which has low amounts of sulfur or is free of sulfur). Therefore, a lower temperature for hydroprocessing may be used (e.g., 450° F.-500° F. inlet) (as compared to temperatures used for coprocessing mineral-biocomponent feedstocks), and an exothermic heat release during hydroprocessing the biocomponent feedstock (and subsequent effluent removal from the reactor) can be tolerated, e.g. without affecting the metallurgical properties of the outlet of the reactor. It has been discovered that use of two reactors enables synergistic effects in the combined process—for example the exchange of heat between the two reactors. For example, the use of this configuration provides higher total feedrate of biocomponent feedstock plus mineral hydrocarbon feedstock versus coprocessing the mixed mineral hydrocarbon feedstock/biocomponent feedstock in a single reactor.

In embodiments where a mineral hydrocarbon feedstock is hydroprocessed in a first reactor disposed upstream from a second reactor (e.g., in series) that hydroprocesses a biocomponent feedstock, hydrogen content present in the first reactor effluent can be introduced along with the first reactor effluent to the second reactor. Accordingly, hydrogen from an external source need not be introduced to the second reactor (or a lesser amount of hydrogen from an external source is introduced to the second reactor as compared to conventional hydroprocessing of biocomponent feedstocks).

It has been further discovered that the effluent from the first reactor and the second reactor can be mixed and introduced to a separator (such as a liquid-vapor separator) such that, for example, water can be removed from the mixture. The use of one separator system improves process efficiency, e.g. less utilities and capital cost.

Processes and apparatus of the present disclosure can provide fuel products having increased biofuel content (e.g., fuel product formed from a biocomponent feedstock), as compared to fuel products formed by, for example, coprocessing in one reactor. Processes and apparatus of the present disclosure provide increased energy efficiency, reduced fuel production cost, and improved hydrogen management, as compared to conventional processes and apparatus.

As used herein, a “first reactor” and a “second reactor” do not indicate a particular sequence in which the processes performed in the reactors must be performed, and the terms are merely intended to provide clarity of description of processes and apparatus generally.

### First Hydroprocess Reactor

### Mineral Feedstocks

A mineral feedstock (also referred to as a mineral hydrocarbon feedstock) refers to a conventional (e.g., non-biocomponent) feedstock, typically derived from crude oil and that has optionally been subjected to one or more separation and/or other refining processes. In at least one embodiment, the mineral feedstock can be a petroleum feedstock boiling in, for example, (1) the diesel range or above, (2) the light naphtha range or above, or (3) the heavy naphtha range or above. Examples of suitable feedstocks can include virgin distillates, hydrotreated virgin distillates, kerosene, diesel boiling range feeds (such as hydrotreated diesel boiling range feeds), light cycle oils, atmospheric gasoils, or combination(s) thereof.

Mineral feedstocks can be relatively free of nitrogen (such as a previously hydrotreated feedstock) or can have a nitrogen content from about 1 wppm to about 2000 wppm nitrogen, for example from about 50 wppm to about 1500 wppm or from about 75 to about 1000 wppm.

In at least one embodiment, a mineral feedstock feedstock can be a mineral feedstock with a relatively low sulfur content, such as a hydrotreated mineral feedstock. Using a mineral feedstock for blending that contains a sufficiently low sulfur content can allow a resulting product to meet a desired sulfur specification. In some embodiments, the mineral feedstock can have a sulfur content from about 1 wppm to about 10,000 wppm sulfur, for example from about 10 wppm to about 5,000 wppm or from about 100 wppm to about 2,500 wppm.

### Processes

The present disclosure provides processes for hydroprocessing a mineral hydrocarbon feedstock in a first reactor. In at least one embodiment, hydroprocessing includes introducing a mineral hydrocarbon feedstock, hydrogen, and a catalyst to a first reactor.

The first reactor can be any suitable reactor, such as any suitable fixed bed reactor, slurry bed reactor, ebullating bed reactor, or batch high-pressure reactor, and may include a single reactor or multiple reactors in series or in parallel.

The present disclosure provides hydroprocessing processes to treat a plurality of feedstocks under wide-ranging reaction conditions. It is within the scope of the present disclosure that more than one type of hydroprocessing catalyst composition can be used in the same reaction vessel/reactor. The present disclosure provides processes for hydroprocessing a mineral hydrocarbon feedstock which further includes obtaining a first reactor effluent with a reduced content or removal of sulfur, nitrogen, oxygen, metals, or other contaminants present in the mineral hydrocarbon feedstock.

Prior to introduction to a first reactor, the mineral hydrocarbon feedstock may be mixed/combined/blended with hydrogen (such as a treat gas including hydrogen), thus forming a mineral hydrocarbon feedstock/hydrogen mixture as a feed to the first reactor. The mineral hydrocarbon feedstock and hydrogen may be combined in any order. The mineral hydrocarbon feedstock and the hydrogen may be combined prior to introducing the mixture to a catalyst. Alternatively, the mineral hydrocarbon feedstock and the hydrogen may be introduced as separate streams into the first reactor. Hydrogen can be obtained from renewable sources. For example, hydrogen can be obtained from electrolysis by electricity from wind or solar power sources, or hydrogen can be obtained from hydrogen manufacture using biomethane.

The feed rate of the mineral hydrocarbon feedstock (or combined mineral hydrocarbon feedstock+hydrogen) can be introduced to the first reactor at a liquid hourly space velocity (LHSV) of from about 0.05 h⁻¹ to about 15 h⁻¹, such as from about 0.1 h⁻¹ to about 12.5 h⁻¹, such as from about 0.5 h⁻¹ to about 10 h⁻¹, such as from about 1 h⁻¹ to about 8 h⁻¹, alternatively from about 5 h⁻¹ to about 25 h⁻¹, such as from about 10 h⁻¹ to about 20 h⁻¹, alternatively from about 5 h⁻¹ to about 10 h⁻¹. Alternatively, the LHSV of the mineral hydrocarbon feedstock (or combined mineral hydrocarbon feedstock+hydrogen) may be of from about 15 h⁻¹ to about 100 h⁻¹, such as from about 25 h⁻¹ to about 75 h⁻¹, such as from about 40 h⁻¹ to about 60 h⁻¹ .

Hydroprocessing the mineral hydrocarbon feedstock in the first reactor can be performed at a temperature of from about 200° C. (392° F.) to about 450° C. (842° F.), such as from about 250° C. (482° F.) to about 400° C. (752° F.), such as from about 275° C. (527° F.) to about 350° C. (662° F.), such as about 343° C. (650° F.). Hydroprocessing the mineral hydrocarbon feedstock in the first reactor can be performed at a pressure of from about atmospheric pressure to about 3,000 psig, such as from about 50 psig to about 3,000 psig, such as from about 200 psig to about 800 psig, or from about 300 psig to about 500 psig.

In at least one embodiment, hydrogen (e.g., treat gas) is present in the first reactor at a pressure of from about 72.51 psig to about 4351.1 psig (about 0.5 MPag to about 30 MPag), such as from about 145 psig to about 3625.9 psig (about 1 MPag to about 25 MPag), such as from about 217.6 psig to about 2900.75 psig (about 1.5 MPag to about 20 MPag).

Hydrogen (e.g., treat gas) can be introduced to the reactor, separately or mixed with the mineral hydrocarbon feedstock, at a pressure of from atmospheric pressure to about 5,000 psig, such as from about 100 psig to about 1000 psig, such as from about 200 psig to about 800 psig, such as from about 300 psig to about 500 psig; and/or a flow rate of from about 10 scf/b to about 20,000 scf/b, such as from about 200 scf/b to about 15,000 scf/b, such as from about 500 scf/b to about 10,000 scf/b, such as from about 3,000 scf/b to about 5,000 scf/b, alternatively from about 1,000 scf/b to about 3,000 scf/b.

It should be understood that hydroprocessing can be practiced in one or more reaction zones, in either countercurrent flow or co-current flow mode. By countercurrent flow mode is meant a process mode in which the feedstock flows in a direction opposite to the flow of hydrogen. By co-current flow mode is meant a process mode in which the feedstock flows in a direction substantially similar to (e.g., the same as) the flow of hydrogen.

Process conditions applicable for the use of the catalyst compositions described herein may vary widely depending on the feedstock to be treated. Thus, as the boiling point of the feedstock increases, the severity of the conditions may also increase. Table 1 serves to illustrate non-limiting example conditions for a range of feedstocks for use in processes of the present disclosure.

TABLE 1

| | | | | Space | |
|---|---|---|---|---|---|
| | Boiling | Temper- | Pres- | Veloc- | H₂ Gas |
| Feed- | Range | ature | sure | ity v/v/ | rate |
| stock | (° C.) | (° C.) | (bar) | hour | (scf/b) |
| Naphtha | 25-210 | 100-370 | 10-60 | 0.5-10 | 100-2,000 |
| Diesel | 150-350 | 200-400 | 15-150 | 0.2-10 | 500-6,000 |
| (Kerosene/ | | | | | |
| Jet Fuels) | | | | | |
| Heavy | 325-475 | 260-430 | 15-170 | 0.3-2 | 1,000-6,000 |
| Gas Oil | | | | | |
| Lube Oil | 290-550 | 200-450 | 6-210 | 0.2-5 | 100-10,000 |
| Residuum | 10-50% > | 340-450 | 65-1,100 | 0.1-1 | 2,000-10,000 |
| | 500 | | | | |

### First Reactor Catalysts

Conventional hydroprocessing catalysts can be utilized for hydroprocessing the mineral hydrocarbon feedstock. Suitable hydroprocessing catalysts for use include those comprising (i) one or more bulk metals and/or (ii) one or more metals on a support. The metals can be in elemental form or in the form of a compound. In one or more embodiments, the hydroprocessing catalyst includes at least one metal from any of Groups 5 to 10 of the Periodic Table of the Elements (tabulated as the Periodic Chart of the Elements, The Merck Index, Merck & Co., Inc., 1996). Examples of such catalytic metals include, but are not limited to, vanadium, chromium, molybdenum, tungsten, manganese, technetium, rhenium, iron, cobalt, nickel, ruthenium, palladium, rhodium, osmium, iridium, platinum, or mixtures thereof.

In one or more embodiments, the catalyst has a total amount of Groups 5 to 10 metals per gram of catalyst of at least 0.0001 grams, or at least 0.001 grams or at least 0.01 grams, in which grams are calculated on an elemental basis. For example, the catalyst can include a total amount of Group 5 to 10 metals in a range of from 0.0001 grams to 0.6 grams, or from 0.001 grams to 0.3 grams, or from 0.005 grams to 0.1 grams, or from 0.01 grams to 0.08 grams. In a particular embodiment, the catalyst further includes at least one Group 15 element. An example of a Group 15 element is phosphorus. When a Group 15 element is utilized, the catalyst can include a total amount of elements of Group 15 in a range of from 0.000001 grams to 0.1 grams, or from 0.00001 grams to 0.06 grams, or from 0.00005 grams to 0.03 grams, or from 0.0001 grams to 0.001 grams, in which grams are calculated on an elemental basis.

In at least one embodiment, the catalyst includes at least one Group 6 metal. Examples of a Group 6 metal include chromium, molybdenum and tungsten. The catalyst may contain, per gram of catalyst, a total amount of Group 6 metals of at least 0.00001 grams, or at least 0.01 grams, or at least 0.02 grams, in which grams are calculated on an elemental basis. For example, the catalyst can contain a total amount of Group 6 metals per gram of catalyst of from 0.0001 grams to 0.6 grams, or from 0.001 grams to 0.3 grams, or from 0.005 grams to 0.1 grams, or from 0.01 grams to 0.08 grams, the number of grams being calculated on an elemental basis.

In some embodiments, the catalyst includes at least one Group 6 metal and further includes at least one metal from Group 5, Group 7, Group 8, Group 9, or Group 10. Such catalysts can contain, e.g., the combination of metals at a molar ratio of Group 6 metal to Group 5 metal in a range of from 0.1 to 20, 1 to 10, or 2 to 5, in which the ratio is on an elemental basis. Alternatively, the catalyst can contain the combination of metals at a molar ratio of Group 6 metal to a total amount of Groups 7 to 10 metals in a range of from 0.1 to 20, 1 to 10, or 2 to 5, in which the ratio is on an elemental basis.

In at least one embodiment, a catalyst may be selected from nickel, cobalt, tungsten, molybdenum, or combination(s) thereof. For example, when the catalyst includes at least one Group 6 metal and one or more metals from Groups 9 or 10, e.g., molybdenum-cobalt and/or tungsten-nickel, these metals may be present, e.g., at a molar ratio of Group 6 metal to Groups 9 and 10 metals in a range of from 1 to 10, or from 2 to 5, in which the ratio is on an elemental basis. When the catalyst includes at least one of Group 5 metal and at least one Group 10 metal, these metals can be present, e.g., at a molar ratio of Group 5 metal to Group 10 metal in a range of from 1 to 10, or from 2 to 5, where the ratio is on an elemental basis. The catalyst may further include inorganic oxides, e.g., as a binder and/or support. For example, the catalyst can include (i)≥1.0 wt % of one or more metals selected from Groups 6, 8, 9, and 10 of the Periodic Table and (ii)≥1.0 wt % of an inorganic oxide, the weight percents being based on the weight of the catalyst.

In one or more embodiments, the catalyst is a bulk multimetallic hydroprocessing catalyst with or without binder. In at least one embodiment, the catalyst is a bulk trimetallic catalyst comprised of two Group 8 metals, such as Ni and Co and one Group 6 metal, such as Mo.

A support may be incorporated into (or deposited on) one or more catalytic metals, e.g., one or more metals of Groups 5 to 10 and/or Group 15, to form the hydroprocessing catalyst. The support can be a porous material. For example, the support can include one or more refractory oxides, porous carbon-based materials, zeolites, or combinations thereof suitable refractory oxides include, e.g., alumina, silica, silica-alumina, titanium oxide, zirconium oxide, magnesium oxide, and mixtures thereof. Suitable porous carbon-based materials include activated carbon and/or porous graphite. Examples of zeolites include, e.g., Y-zeolites, beta zeolites, mordenite zeolites, ZSM-5 zeolites, and ferrierite zeolites. Additional examples of support materials include gamma alumina, theta alumina, delta alumina, alpha alumina, or combinations thereof. The amount of gamma alumina, delta alumina, alpha alumina, or combinations thereof, per gram of catalyst support, can be in a range of from 0.0001 grams to 0.99 grams, or from 0.001 grams to 0.5 grams, or from 0.01 grams to 0.1 grams, or at most 0.1 grams, as determined by x-ray diffraction. In a particular embodiment, the hydroprocessing catalyst is a supported catalyst, and the support includes at least one alumina, e.g., theta alumina, in an amount in the range of from 0.1 grams to 0.99 grams, or from 0.5 grams to 0.9 grams, or from 0.6 grams to 0.8 grams, the amounts being per gram of the support. The amount of alumina can be determined using, e.g., x-ray diffraction. In alternative embodiments, the support can include at least 0.1 grams, or at least 0.3 grams, or at least 0.5 grams, or at least 0.8 grams of theta alumina.

When a support is utilized, the support can be impregnated with the desired metals to form the hydroprocessing catalyst. The support can be heat-treated at temperatures in a range of from 400° C. to 1200° C., or from 450° C. to 1000° C., or from 600° C. to 900° C., prior to impregnation with the metals. In certain embodiments, the hydroprocessing catalyst can be formed by adding or incorporating the Groups 5 to 10 metals to shaped heat-treated mixtures of support. This type of formation is generally referred to as overlaying the metals on top of the support material. Optionally, the catalyst is heat treated after combining the support with one or more of the catalytic metals, e.g., at a temperature in the range of from 150° C. to 750° C., or from 200° C. to 740° C., or from 400° C. to 730° C. Optionally, the catalyst is heat treated in the presence of hot air and/or oxygen-rich air at a temperature in a range between 400° C. and 1000° C. to remove volatile matter such that at least a portion of the Groups 5 to 10 metals are converted to their corresponding metal oxide. In other embodiments, the catalyst can be heat treated in the presence of oxygen (e.g., air) at temperatures in a range of from 35° C. to 500° C., or from 100° C. to 400° C., or from 150° C. to 300° C. Heat treatment can take place for a period of time in a range of from 1 to 3 hours to remove a majority of volatile components without converting the Groups 5 to 10 metals to their metal oxide form. Catalysts prepared by such a method are generally referred to as “uncalcined” catalysts or “dried.” Such catalysts can be prepared in combination with a sulfiding method, with the Groups 5 to 10 metals being substantially dispersed in the support. When the catalyst includes a theta alumina support and one or more Groups 5 to 10 metals, the catalyst is generally heat treated at a temperature ≥400° C. to form the hydroprocessing catalyst. Typically, such heat treating is conducted at temperatures ≤1200° C.

In one or more embodiments, the hydroprocessing catalysts include transition metal sulfides dispersed on high surface area supports. The structure of the hydrotreating catalysts is made of 3-15 wt % Group 6 metal oxide and 2-8 wt % Group 8 metal oxide and these catalysts can be sulfided prior to use.

The catalyst can be in shaped forms, e.g., one or more of discs, pellets, extrudates, etc., though this is not required. Non-limiting examples of such shaped forms include those having a cylindrical symmetry with a diameter in the range of from about 0.79 mm to about 3.2 mm ( 1/32^{nd} to ⅛^{th} inch), from about 1.3 mm to about 2.5 mm ( 1/20^{th} to 1/10^{th} inch), or from about 1.3 mm to about 1.6 mm ( 1/20^{th} to 1/16^{th} inch). Similarly-sized non-cylindrical shapes are also contemplated herein, e.g., trilobe, quadralobe, etc. Optionally, the catalyst has a flat plate crush strength in a range of from about 50-500 N/cm, or about 60-400 N/cm, or about 100-350 N/cm, or about 200-300 N/cm, or about 220-280 N/cm.

Porous catalysts, including those having conventional pore characteristics, may be used. When a porous catalyst is utilized, the catalyst can have a pore structure, pore size, pore volume, pore shape, pore surface area, etc., in ranges that are characteristic of conventional hydroprocessing catalysts. Since feedstock might include fairly large molecules, catalysts with large pore size can be used. For example, the catalyst can have a median pore size that is effective for hydroprocessing SCT molecules, such catalysts having a median pore size from about 30 Å to about 1000 Å, or about 50 Å to about 500 Å, or about 60 Å to about 300 Å. Further, catalysts with bi-modal pore system, having from about 150-250 Å pores with feeder pores from about 250-1000 Å in the support are more favorable. Pore size can be determined according to ASTM Method D4284-07 Mercury Porosimetry.

In at least one embodiment, the hydroprocessing catalyst has a median pore diameter from about 50 Å to about 200 Å. Alternatively, the hydroprocessing catalyst has a median pore diameter from about 90 Å to about 180 Å, or about 100 Å to about 140 Å, or about 110 Å to about 130 Å. In another embodiment, the hydroprocessing catalyst has a median pore diameter ranging from about 50 Å to about 150 Å. Alternatively, the hydroprocessing catalyst has a median pore diameter in a range of from about 60 Å to about 135 Å, or from about 70 Å to about 120 Å. In yet another alternative, hydroprocessing catalysts having a larger median pore diameter are utilized, e.g., those having a median pore diameter in a range of from about 180 Å to about 500 Å, or about 200 Å to about 300 Å, or about 230 Å to about 250 Å.

The hydroprocessing catalyst can have a pore size distribution that is not so great as to significantly degrade catalyst activity or selectivity. For example, the hydroprocessing catalyst can have a pore size distribution in which at least 60% of the pores have a pore diameter within 45 Å, 35 Å, or 25 Å of the median pore diameter. In certain embodiments, the catalyst has a median pore diameter in a range of from about 50 Å to about 180 Å, or from about 60 Å to about 150 Å, with at least 60% of the pores having a pore diameter within 45 Å, 35 Å, or 25 Å of the median pore diameter.

When a porous catalyst is utilized, the catalyst can have, e.g., a pore volume >0.3 cm³/g, such >0.7 cm³/g, or >0.9 cm³/g. In certain embodiments, pore volume can be from about 0.3 cm³/g to about 0.99 cm³/g, about 0.4 cm³/g to about 0.8 cm³/g, or about 0.5 cm³/g to about 0.7 cm³/g.

In some embodiments, a relatively large surface area can be desirable. As an example, the hydroprocessing catalyst can have a surface area ≥60 m²/g, or ≥100 m²/g, or ≥120 m²/g, or ≥170 m²/g, or ≥220 m²/g, or ≥270 m²/g; such as from about 100 m²/g to about 300 m²/g, or about 120 m²/g to about 270 m²/g, or about 130 m²/g to about 250 m²/g, or about 170 m²/g to about 220 m²/g.

The catalyst can be one that includes one or more of Co, Fe, Ru, Ni, Mo, W, Pd, and Pt, supported on amorphous Al₂O₃ and/or SiO₂ (ASA). Exemplary catalysts can be a Ni—Co—Mo/Al₂O₃type catalyst, or Pt—Pd/Al₂O₃—SiO₂, Ni—W/Al₂O₃, Ni—Mo/Al₂O₃, or Fe, Fe—Mo supported on a non-acidic support such as carbon black or carbon black composite, or Mo supported on a nonacidic support such as TiO₂ or Al₂O₃/TiO₂.

The catalyst may be one that includes predominantly one or more of a zeolite or Co, Mo, P, Ni, Pd supported on ASA and/or zeolite. Exemplary catalysts include USY or VUSY Zeolite Y, Co—Mo/Al₂O₃, Ni—Co—Mo/Al₂O₃, Pd/ASA-Zeolite Y.

In some aspects, a guard bed including an inexpensive and readily available catalyst, such as Co—Mo/Al₂O₃, followed by H₂S and NH₃ removal is used, for example, if the S and N content of the feedstock is too high and certain catalysts are used.

In some embodiments, the catalyst can be one that includes predominantly one or more of a zeolite or Co, Mo, P, Ni, Pd supported on ASA and/or zeolite, and the catalyst in the second reactor can be one that includes one or more of Ni, Mo, W, Pd, and Pt, supported on amorphous Al₂O₃ and/or SiO₂ (ASA). In this configuration, the exemplary catalysts for use can be USY or VUSY Zeolite Y, Co—Mo/Al₂O₃, Ni—Co—Mo/Al₂O₃, Pd/ASA-Zeolite Y and/or Ni—Co—Mo/Al₂O₃ type catalyst, or Pt—Pd/Al₂O₃—SiO₂, Ni—W/Al₂O₃, Ni—Mo/Al₂O₃, or Fe, Fe—Mo supported on a non-acidic support such as carbon black or carbon black composite, or Mo supported on a nonacidic support such as TiO₂ or Al₂O₃/TiO₂. The catalyst can be one that includes one or more of Co, Fe, Ru, Ni, Mo, W, Pd, and Pt, supported on amorphous Al₂O₃ and/or SiO₂ (ASA). Exemplary catalysts for use can be a Ni—Co—Mo/Al₂O₃ type catalyst, or Pt—Pd/Al₂O₃—SiO₂, Ni—W/Al₂O₃, Ni—Mo/Al₂O₃, or Fe, Fe—Mo supported on a non-acidic support such as carbon black or carbon black composite, or Mo supported on a nonacidic support such as TiO₂ or Al₂O₃/TiO₂.

### First Reactor Effluent

In various aspects, a first reactor effluent is provided. It is contemplated that the first reactor effluent is intended to encompass a product resultant from hydroprocessing a mineral hydrocarbon feedstock. The first reactor effluent may include sulfur, paraffins, and/or aromatics in suitable amounts and have desirable properties such as, but not limited to, pour point and viscosity, such that the first reactor effluent may be a suitable fuel oil and/or a suitable fuel oil blendstock.

Processes for hydroprocessing a mineral hydrocarbon feedstock may include obtaining a first reactor effluent having a reduced content or removal of sulfur present in the mineral hydrocarbon feedstock (e.g., sulfur content of from 0 wppm to about 5,000 wppm, based on the total weight of the first reactor effluent, such as from 0 wppm to about 2,000 wppm, such as from about 10 wppm to about 200 wppm).

Furthermore, the first reactor effluent can have a nitrogen content of about 100 ppm or less, based on the total weight of the first reactor effluent, such as a nitrogen content of from about 5 ppm to about 100 ppm, such as from about 25 ppm to about 100 ppm, such as from about 25 ppm to about 75 ppm, such as from about 50 ppm to about 75 ppm.

Advantageously, due its low sulfur content, the first reactor effluent may be suitable as an ULSFO and/or a LSFO. The first reactor effluent can also be used to extend the ULSFO pool and/or LSFO pool, which may permit the blending of LSFO with a ULSFO, blending of RSFO with a LSFO, and/or blending of a more viscous blendstock material with a LSFO or an ULSFO. Further, using the first reactor effluent as a blendstock can avoid the use of a distillate, which may have an undesirably lower energy content. Additionally, the first reactor effluent may be used to correct ULSFO and/or LSFO, which may be off-spec with respect to sulfur content.

Additionally or alternatively, the first reactor effluent may have a paraffin content. For example, the first reactor effluent may have a paraffin content, based on total weight of the first reactor effluent, of ≥about 1 wt %, ≥about 5 wt %, ≥about 10 wt %, ≥about ≥15 wt %, ≥about 20 wt %, ≥about 25 wt %, or ≥about 30 wt %. The first reactor effluent may have a paraffin content, based on total weight of the first reactor effluent, of ≤about 75 wt %, ≤about 60 wt %, ≤about 50 wt %, or ≤about 40 wt %. Additionally or alternatively, the first reactor effluent may have a paraffin content, based on total weight of the first reactor effluent, of about 1 wt % to about 75 wt %, about 5 wt % to about 60 wt %, about 10 wt % to about 60 wt %, or about 10 wt % to about 30 wt %.

Additionally or alternatively, the first reactor effluent may include an amount of aromatics, including alkyl-functionalized derivatives. For example, the first reactor effluent can include ≤95 wt %, ≤90 wt %, ≤80 wt %, ≤70 wt %, ≤60 wt %, ≤50 wt %, ≤40 wt %, or ≤30 wt % aromatics, including those having one or more hydrocarbon substituents, such as from 1 to 6 or 1 to 4 or 1 to 3 or 1 to 2 hydrocarbon substituents. The first reactor effluent may include ≥5 wt %, ≥10 wt %, ≥15 wt %, ≥20 wt %, ≥25 wt %, or ≥30 wt % aromatics. Examples of such hydrocarbon groups include, but are not limited to, those selected from the group consisting of C₁-C₆ alkyl, wherein the hydrocarbon groups can be branched or linear and the hydrocarbon groups can be the same or different. Optionally, the first reactor effluent can include ≥90.0 wt % based on the weight of the first reactor effluent of one or more of benzene, ethylbenzene, trimethylbenzene, xylenes, toluene, naphthalenes, alkylnaphthalenes (e.g., methylnaphthalenes), tetralins, alkyltetralins (e.g., methyltetralins), phenanthrenes, or alkyl phenanthrenes.

The first reactor effluent may be substantially free of molecules having unsaturated (e.g., terminal unsaturates), for example, vinyl aromatics. The term “substantially free” in this context means that the first reactor effluent includes ≤10.0 wt % (e.g., ≤5.0 wt % or ≤1.0 wt %) vinyl aromatics, based on the weight of the first reactor effluent.

Generally, the first reactor effluent contains sufficient amount of molecules having one or more aromatic cores. For example, the first reactor effluent can include ≥50.0 wt % of molecules having at least one aromatic core (e.g., ≥60.0 wt %, such as ≥70 wt %) based on the total weight of the first reactor effluent. In an embodiment, the first reactor effluent can include (i) ≥60.0 wt % of molecules having at least one aromatic core and (ii) ≤1.0 wt % of vinyl aromatics, the weight percents being based on the weight of the first reactor effluent.

Additionally or alternatively, the first reactor effluent may have naphthenes. For example, the first reactor effluent may include naphthenes having a single-ring (e.g., cyclopropane, cyclobutane, cyclopentane, cyclohexane, cycloheptane, cyclooctane, etc.) and/or having a double-ring (e.g., decahydronapthalene, octahydropentalene, etc.) in an amount of ≤5.0 wt %, ≤4.0 wt %, ≤3.0 wt %, ≤2.0 wt %, ≤1.5 wt %, ≤1.0 wt %, ≤0.75 wt %, ≤0.50 wt %, ≤0.10 wt %, or about 0.050 wt %. For example, the first reactor effluent may include naphthenes having a single-ring in an amount of 0.050 wt % to 5.0 wt %, 0.050 wt % to 1.0 wt %, 0.050 wt % to 0.50 wt %, or 0.050 wt % to 0.10 wt %. Additionally or alternatively, the first reactor effluent may include naphthenes having a double-ring in an amount of 0.10 wt % to 5.0 wt %, 0.10 wt % to 3.0 wt %, 0.10 wt % to 1.0 wt % or 0.10 wt % to 0.75 wt %.

Multi-ring classes described above can include ring compounds having hydrogen, alkyl, or alkenyl groups bound thereto, e.g., one or more of H, CH₃, C₂ H₅ through Cₘ H₂ₘ₊₁. Generally, m is in the range of from 1 to 6, e.g., from 1 to 5.

Additionally or alternatively, the first reactor effluent may have a suitable asphaltenes content, which also may increase its compatibility with various residual fuel oils.

For example, the first reactor effluent may have an asphaltenes content, based on total weight of the first reactor effluent, of ≤about 10 wt %, ≤about 5 wt %, ≤about 3 wt %, ≤about 1 wt %, ≤about 0.5 wt %, ≤about 0.4 wt %, ≤about 0.3 wt %, or ≤about 0.2 wt %, for example about 0.15 wt %, according to ASTM D975. Additionally or alternatively, the first reactor effluent may have an asphaltenes content, based on total weight of the first reactor effluent, of about 0.1 wt % to about 1 wt %, about 0.1 wt % to about 0.5 wt %, about 0.1 wt % to about 0.4 wt %, or about 0.15 wt % to about 0.35 wt %, according to ASTM D975.

### Second Hydroprocess Reactor

A biocomponent feedstock is hydroprocessed in a second hydroprocess reactor (“second reactor”). Advantageously, the first reactor effluent has an elevated temperature (e.g., greater than ambient temperature) as it exits the first reactor. Therefore, the first reactor effluent may be introduced to the second hydroprocess reactor, and the temperature (e.g., heat) of the first reactor effluent being introduced to the second reactor is used to provide temperature (e.g., heat) to the second hydroprocess reactor. In such embodiments, the second hydroprocess reactor can operate using less external energy input to the second reactor during use, which reduces the overall energy demand of processes and apparatus of the present disclosure as compared to conventional processes and apparatus. Additionally or alternatively, the first reactor and the second reactor can be operated in a “partial-parallel, partial-series” configuration, e.g., as described in more detail below, which provides improved throughput and production of fuel products of the present disclosure.

Additionally or alternatively, the first reactor effluent has a hydrogen content due to the presence of hydrogen in the first reactor. Therefore, hydrogen content present in the first reactor effluent can be introduced along with the first reactor effluent to the second reactor. Accordingly, hydrogen from an external source need not be introduced to the second reactor (or a lesser amount of hydrogen from an external source is introduced to the second reactor as compared to conventional hydroprocessing of biocomponent feedstocks).

Additionally or alternatively, a separation unit (such as a gas-liquid separation unit) is optionally coupled with and disposed between the first reactor and the second reactor to remove gas products from the first reactor effluent and provide a separation unit effluent having a first reactor effluent having reduced gas products and a separation unit effluent having gas products (such as hydrogen). The separation unit effluent having gas products is then introduced to the second reactor. In some embodiments, additional hydrogen can be introduced to the second reactor.

### Biocomponent Feedstocks

As mentioned above, the present disclosure provides for hydroprocessing a biocomponent feedstock in a second reactor (e.g., second hydroprocess reactor). A feedstock derived from a biological source (i.e., a biocomponent feedstock) refers to a feedstock derived from a biological raw material component, such as vegetable fats/oils or animal fats/oils, fish oils, pyrolysis oils, and algae lipids/oils, as well as components of such materials, and in some embodiments can include one or more types of lipid compounds. Lipid compounds are typically biological compounds that are insoluble in water, but soluble in one or more solvents. Non-limiting examples of such solvents include alcohols, ethers, chloroform, alkyl acetates, benzene, or combination(s) thereof.

A biocomponent feedstock of the present disclosure can include at least about 10 wt % of feedstock based on a biocomponent source or sources, or at least about 25 wt %, or at least about 50 wt %, or at least about 75 wt %, or at least about 90 wt %, or at least about 95 wt %. Additionally or alternatively, the feedstock can be entirely (e.g., 100 wt %) a feedstock from a biocomponent source, or the feedstock can include about 99 wt % or less of a feedstock based on a biocomponent source, or about 90 wt % or less, or about 75 wt % or less, or about 50 wt % or less.

Major classes of lipids may include fatty acids, glycerol-derived lipids (including fats, oils and phospholipids), sphingosine-derived lipids (including ceramides, cerebrosides, gangliosides, and sphingomyelins), steroids and their derivatives, terpenes and their derivatives, fat-soluble vitamins, certain aromatic compounds, and long-chain alcohols and waxes.

Examples of vegetable oils that can be used may include rapeseed (canola) oil, soybean oil, coconut oil, sunflower oil, palm oil, palm kernel oil, peanut oil, linseed oil, tall oil, corn oil, castor oil, jatropha oil, jojoba oil, olive oil, flaxseed oil, camelina oil, safflower oil, babassu oil, tallow oil and rice bran oil.

Vegetable oils as referred to herein can include processed vegetable oil material. Non-limiting examples of processed vegetable oil material include fatty acids and fatty acid alkyl esters. Alkyl esters typically include C₁-C₅ alkyl esters, such as methyl, ethyl, or propyl esters.

Examples of animal fats that can be used in accordance with the present disclosure include, but are not limited to, beef fat (tallow), hog fat (lard), turkey fat, fish fat/oil, and chicken fat. The animal fats can be obtained from any suitable source including restaurants and meat production facilities.

Animal fats as referred to herein also include processed animal fat material. Non-limiting examples of processed animal fat material include fatty acids and fatty acid alkyl esters. Alkyl esters typically include Ci-0₅ alkyl esters, such as methyl, ethyl, or propyl esters.

Algae oils or lipids can typically be contained in algae in the form of membrane components, storage products, and/or metabolites. Certain algal strains, such as microalgae, such as cyanobacteria, can contain proportionally high levels of lipids. Algal sources for the algae oils can contain varying amounts, e.g., from 2 wt % to 40 wt % of lipids, based on total weight of the biomass itself.

Algal sources for algae oils can include, but are not limited to, unicellular and multicellular algae. Examples of such algae can include a rhodophyte, chlorophyte, heterokontophyte, tribophyte, glaucophyte, chlorarachniophyte, euglenoid, haptophyte, cryptomonad, dinoflagellum, phytoplankton, and the like, and combinations thereof. In one embodiment, algae can be of the classes Chlorophyceae and/or Haptophyta. Specific species can include, but are not limited to, Neochloris oleoabundans, Scenedesmus dimorphus, Euglena gracilis, Phaeodactylum tricornutum, Pleurochrysis carterae, Prymnesium parvum, Tetraselmis chuff, and Chlamydomonas reinhardtii. Additional or alternative algal sources can include one or more microalgae of the Achnanthes, Amphiprora, Amphora, Ankistrodesmus, Asteromonas, Boekelovia, Borodinella, Botryococcus, Bracteococcus, Chaetoceros, Carteria, Chlamydomonas, Chlorococcum, Chlorogonium, Chlorella, Chroomonas, Chrysosphaera, Cricosphaera, Crypthecodinium, Cryptomonas, Cyclotella, Dunaliella, Ellipsoidon, Emiliania, Eremosphaera, Ernodesmius, Euglena, Franceia, Fragilaria, Gloeothamnion, Haematococcus, Halocafeteria, Hymenomonas, Isochrysis, Lepocinclis, Micractinium, Monoraphidium, Nannochloris, Nannochloropsis, Navicula, Neochloris, Nephrochloris, Nephroselmis, Nitzschia, Ochromonas, Oedogonium, Oocystis, Ostreococcus, Pavlova, Parachlorella, Pascheria, Phaeodactylum, Phagus, Platymonas, Pleurochrysis, Pleurococcus, Prototheca, Pseudochlorella, Pyramimonas, Pyrobotrys, Scenedesmus, Skeletonema, Spyrogyra, Stichococcus, Tetraselmis, Thalassiosira, Viridiella, and Volvox species, and/or one or more cyanobacteria of the Agmenellum, Anabaena, Anabaenopsis, Anacystis, Aphanizomenon, Arthrospira, Asterocapsa, Borzia, Calothrix, Chamaesiphon, Chlorogloeopsis, Chroococcidiopsis, Chroococcus, Crinalium, Cyanobacterium, Cyanobium, Cyanocystis, Cyanospira, Cyanothece, Cylindrospermopsis, Cylindrospermum, Dactylococcopsis, Dermocarpella, Fischerella, Fremyella, Geitleria, Geitlerinema, Gloeobacter, Gloeocapsa, Gloeothece, Halospirulina, Iyengariella, Leptolyngbya, Limnothrix, Lyngbya, Microcoleus, Microcystis, Myxosarcina, Nodularia, Nostoc, Nostochopsis, Oscillatoria, Phormidium, Planktothrix, Pleurocapsa, Prochlorococcus, Prochloron, Prochlorothrix, Pseudanabaena, Rivularia, Schizothrix, Scytonema, Spirulina, Stanieria, Starria, Stigonema, Symploca, Synechococcus, Synechocystis, Tolypothrix, Trichodesmium, Tychonema, and Xenococcus species.

Other biocomponent feedstocks can include any of those which include primarily triglycerides and free fatty acids (FFAs). The triglycerides and FFAs typically contain aliphatic hydrocarbon chains in their structure having from 8 to 36 carbons, such as from 10 to 26 carbons, for example from 14 to 22 carbons. Types of triglycerides can be determined according to their fatty acid constituents. The fatty acid constituents can be readily determined using Gas Chromatography (GC) analysis. This analysis involves extracting the fat or oil, saponifying (hydrolyzing) the fat or oil, preparing an alkyl (e.g., methyl) ester of the saponified fat or oil, and determining the type of (methyl) ester using GC analysis. In one embodiment, a majority (i.e., greater than 50%) of the triglyceride present in the lipid material can include C₁₀ to C₂₆ fatty acid constituents, based on total triglyceride present in the lipid material. Further, a triglyceride is a molecule having a structure corresponding to a reaction product of glycerol and three fatty acids. Although a triglyceride is described herein as having side chains corresponding to fatty acids, it should be understood that the fatty acid component does not necessarily contain a carboxylic acid hydrogen. If triglycerides are present, a majority of triglycerides present in the biocomponent feedstock can be C₁₂ to C₁₈ fatty acid constituents, based on total triglyceride content. Other types of feedstock that are derived from biological raw material components can include fatty acid esters, such as fatty acid alkyl esters (e.g., FAME and/or FAEE).

In various embodiments, the production of propylene can be observed during hydroprocessing of a biocomponent feedstock. Production of propylene is based on processing of triglycerides within the biocomponent feedstock.

Deoxygenation of a biocomponent feedstock generates a substantial amount of heat due to formation of products from a free energy standpoint, such as H₂O and CO₂. For a typical catalyst bed with a bed length of 25-30 feet (about 9-10 meters), a temperature increase across the bed of 100° F. (55° C.) or less can be experienced. If deoxygenation of a biocomponent feedstock with a high oxygen content is performed using a sufficiently reactive catalyst, an exotherm of greater than 100° F. across the catalyst bed can be generated. Blending a biocomponent feedstock with a portion that does not contain oxygen can reduce the exotherm generated across a catalyst bed used for performing deoxygenation.

One option for using a biocomponent feedstock while retaining some of the benefits of adding a feedstock with reduced oxygen content is to use recycled product from processing of biocomponent feedstock as a diluent. A recycled product from processing a biocomponent feedstock is still derived from a biocomponent source, and therefore such a recycled product is counted as a feedstock portion from a biocomponent source. Thus, a feedstock containing 60% biocomponent feedstock that has not been processed and 40% of a recycled product from processing of the biocomponent feedstock would be considered as a feedstock that includes 100% of feedstock from a biocomponent source. As an example, at least a portion of the product from processing of a biocomponent feedstock can be a diesel boiling range product. Such a recycled diesel boiling range product will be deoxygenated, and therefore incorporation of the recycled diesel boiling range product in the feedstock will reduce the exotherm generated during deoxygenation. Adding a recycled diesel boiling range product is also likely to improve the cold flow properties of a biocomponent feedstock. More generally, any convenient product from processing of a biocomponent feedstock can be recycled for blending with the biocomponent feedstock in order to improve the cold flow properties and/or reduce the oxygen content of the input flow to a deoxygenation process. If a recycled product flow is added to the input to a deoxygenation process, the amount of recycled product can correspond to at least about 10 wt % of the feedstock to the second hydroprocess reactor, such as at least about 25 wt %, or at least about 40 wt %. Additionally or alternatively, the amount of recycled product in a feedstock can be about 70 wt % or less, such as about 50 wt % or less, 40 wt % or less, or about 25 wt % or less.

While feedstock dilution can be used to control the exotherm generated across a catalyst bed used for deoxygenation, it is noted that some processing options can also impact the exotherm. One alternative is to use a less reactive catalyst, so that a larger amount of catalyst is needed at a given liquid hourly space velocity (LHSV) in order to deoxygenate a feedstock to a desired level. Another option is to reduce the amount of hydrogen provided for the deoxygenation process. Still another option could be to introduce additional features into a reactor to assist in cooling and/or transporting heat away from a deoxygenation catalyst bed. In combination with selecting an appropriate amount of product recycle and/or blending of another non-oxygenated feed, a desired combination of flow characteristics and heat generation during deoxygenation can be achieved.

With regard to triglyceride content, the feedstock may include at least about 1 wt % of triglycerides, such as at least about 10 wt %, or at least about 25 wt %, or at least about 50 wt %, or at least about 75 wt %, or at least about 90 wt %. Additionally or alternatively, the feedstock can be composed entirely of triglycerides, or the triglyceride content of the feedstock can be about 95 wt % or less, such as about 90 wt % or less, or about 75 wt % or less, or about 50 wt % or less, or about 25 wt % or less. If propylene production is also desirable, feedstocks with higher triglyceride contents can be used, such as feedstocks including at least about 25 wt % of triglycerides, or at least about 50 wt %, or at least about 75 wt %, or at least about 90 wt %.

The biocomponent feedstock can also be characterized relative to the olefin content of the feedstock. The olefin content of a biocomponent feedstock can vary widely depending on the source of the feedstock. For example, a feedstock based on soybean oil may contain up to 100% of molecules that contain at least one degree of unsaturation. Palm oils typically include 25-50 wt % of olefinic molecules, while coconut oil may include 15% or less of olefinic molecules. Depending on the embodiment, a biocomponent feedstock can include at least about 20 wt % olefins, such as at least about 40 wt % olefins, or at least about 50 wt % olefins, or at least about 75 wt % olefins. As defined herein, an olefin refers to any compound that includes an olefin bond. Thus, there are two ways that the wt % of olefins in a feedstock can be modified. If all olefins in a molecule are saturated, the molecule is no longer an olefin. Alternatively, if a molecule is broken down into smaller components, such as by deoxygenation or cracking, the wt % of olefins may be reduced if one or more of the smaller components does not contain an olefin. As an example, a triglyceride with an olefin bond in only one of the three side chains would be considered an olefin as defined herein. Therefore, the entire weight of the triglyceride would count toward the olefin weight percentage in the feed. After a deoxygenation that preserved olefin bonds, only the fatty acid resulting from the side chain including the olefin bond would count toward the olefin weight percentage. The other two fatty acids formed from the side chains would be separate molecules and therefore would not be considered olefins. Thus, even though no olefins were saturated, the weight percentage of olefins in the feedstock would still be lower.

In at least one embodiment, the biocomponent feedstock (such as triglycerides) can be a non-hydrotreated portion. A non-hydrotreated feedstock can typically have an olefin content and an oxygen content similar to the content of the corresponding raw biocomponent material. Examples of suitable biocomponent feedstocks can include food grade vegetable oils, and biocomponent feedstocks that are refined, bleached, and/or deodorized.

Biocomponent based diesel boiling range feedstocks can have a wide range of nitrogen and/or sulfur contents. For example, a biocomponent feedstock based on a vegetable oil source can contain up to about 300 wppm nitrogen. In contrast, a biocomponent feedstock containing whole or ruptured algae can sometimes include a higher nitrogen content. Depending on the type of algae, the nitrogen content of an algae based feedstock can be at least about 2 wt %, for example at least about 3 wt %, at least about 5 wt %, or at least about 10 wt %, and algae with still higher nitrogen contents are known. The sulfur content of a biocomponent feedstock can also vary. In some embodiments, the sulfur content can be about 500 wppm or less, for example about 100 wppm or less, about 50 wppm or less, or about 10 wppm or less.

Aside from nitrogen and sulfur, oxygen can be another heteroatom component in biocomponent feedstock. A biocomponent diesel boiling range feedstock based on a vegetable oil, prior to hydrotreatment, can include up to about 10 wt % oxygen, for example up to about 12 wt % or up to about 14 wt %. Additionally or alternatively, such a biocomponent diesel boiling range feedstock can include at least about 1 wt % oxygen, for example at least about 2 wt %, at least about 3 wt %, at least about 4 wt %, at least about 5 wt %, at least about 6 wt %, or at least about 8 wt %. Further additionally or alternatively, a biocomponent feedstock, prior to hydrotreatment, can include an olefin content of at least about 3 wt %, for example at least about 5 wt % or at least about 10 wt %.

The boiling range for biocomponent feedstocks can vary depending on the biocomponent source. Biocomponent feedstocks with final boiling points up to about 1000° F. (538° C.) may be suitable for use, as the triglycerides within a biocomponent feedstock will have a higher boiling point than the boiling point of the individual chains attached to the glycerol backbone. Mineral feedstocks can be used as a blending component in a biocomponent feedstock and tend to boil at a temperature of from about 215° F. (about 102° C.) to about 800° F. (about 427° C.). For example, a mineral feedstock has an initial boiling point of at least about 215° F. (about 102° C.), for example at least about 250° F. (about 121° C.), at least about 275° F. (about 135° C.), at least about 300° F. (about 149° C.), at least about 325° F. (about 163° C.), at least about 350° F. (about 177° C.), at least about 400° F. (about 204° C.), or at least about 451° F. (about 233° C.). For example, a mineral feedstock can have a final boiling point of about 800° F. (about 427° C.) or less, or about 750° F. (about 399° C.) or less. Additionally or alternatively, a feedstock can be characterized by the boiling point required to boil a specified percentage of the feed. For example, the temperature involved to boil at least 5 wt % of a feedstock is referred to as a “T5” boiling point. A suitable mineral (petroleum) feedstock can have a T5 boiling point of at least about 230° F. (about 110° C.), for example at least about 250° F. (about 121° C.) or at least about 275° F. (about 135° C.). Additionally or alternatively, the mineral (petroleum) feedstock can have a T95 boiling point of about 775° F. (about 418° C.) or less, for example about 750° F. (about 399° C.) or less or about 725° F. (about 385° C.) or less. In another embodiment, the diesel boiling range feedstock can also include kerosene range compounds to provide a feedstock with a boiling range from about 250° F. (about 121° C.) to about 800° F. (about 427° C.).

### Reactions for Oxygen Removal

Oxygen removal during hydroprocessing of a biocomponent feedstock typically occurs via one of three reaction pathways. One potential reaction pathway is hydrodeoxygenation. In a hydrodeoxygenation reaction, oxygen is removed from feedstock molecules as water. The carbon chain for the feedstock molecule remains intact after a typical hydrodeoxygenation reaction. Water is a contaminant that can potentially contribute to deactivation of some conventional hydrotreating catalysts, such as NiMo or CoMo type catalysts. However, by itself water does not lead to corrosion within a reaction system. Additionally, removing oxygen as water maintains the chain length of a feedstock molecule. Maintaining the chain length of molecules intended for use as a fuel or fuel blending product can be beneficial, as it means that a greater percentage of the carbon from the feedstock is incorporated into the final fuel product.

Hydrodecarboxylation removes oxygen by forming CO₂ from biofeeds. This CO₂ forms carbonic acid when combined with water. Carbonic acid corrosion might require metallurgical upgrades to carbon steel in downstream equipment, particularly fin fans, heat exchangers, and other locations that liquid water will be present prior to an amine scrubbing system or other system for removing CO₂.

Hydrodecarbonylation removes oxygen by forming CO from biofeeds. CO is an inhibitor for hydrodesulfurization. For example, 1000 ppm CO can deactivate a conventional CoMo catalyst by 10%. CO is also not removed in appreciable quantities by conventional amine scrubbing systems. As such, CO can build up through gas recycle and can be cascaded to downstream hydrotreatment, dewaxing, and/or hydrofinishing stages. As a result, removing oxygen from a biocomponent feedstock as CO might require the use of pressure swing adsorbers (including rapid cycle pressure swing adsorbers) or other gas cleaning equipment in order to remove CO from a reaction system.

Depending on the conditions present in a reactor, the relative amounts of CO and CO₂ in a reactor can be modified by the water gas shift reaction. The water gas shift reaction is an equilibrium reaction that can convert CO₂ and H₂ into CO and H₂O. Due to the water gas shift reaction, the amount of decarbonylation and decarboxylation may not be clear, due to conversion from one form of carbon oxide to another. Hydrodeoxygenation can be distinguished at least in part from decarbonylation and decarboxylation by characterizing the odd versus even numbered carbons in a deoxygenated product.

Most catalysts used for performing a catalytic deoxygenation of a biocomponent feedstock will be less than 100% selective for a given pathway. Instead, at least some deoxygenation of a feedstock will occur via each of the three pathways mentioned above during a typical catalytic deoxygenation of a feedstock. The relative amounts of deoxygenation by each method will vary depending on the nature of the catalyst and the reaction conditions.

Because feedstocks derived from biological sources typically have carbon chains with even numbers of carbon molecules, hydrodeoxygenation can be distinguished from decarbonylation and decarboxylation based on the carbon chain length of the resulting molecules. Hydrodeoxygenation typically leads to production of molecules with an even number of carbon atoms while decarbonylation and decarboxylation lead to molecules with an odd number of carbon atoms.

### Hydroprocessing Conditions of the Second Hydroprocess Reactor

Typical effective conditions for hydroprocessing a biocomponent feedstock to remove oxygen can include conditions effective for hydrodeoxygenation, decarbonylation, and/or decarboxylation. In some embodiments, such as embodiments including a sulfided Mo catalyst, the effective conditions can be selected to increase the selectivity for removing oxygen via hydrodeoxygenation rather than via decarbonylation or decarboxylation. A variety of conditions may be suitable as effective conditions. The pressure during processing of a biocomponent feedstock for oxygen removal can correspond to a hydrogen partial pressure of about 400 psig (2.8 MPag) or less. At pressures of 400 psig or less, a Group VI metal catalyst or a Group VIII non-noble metal catalyst (optionally with additional physical promoter metals) can perform little or no sulfur removal on a feed. Lower hydrogen partial pressures are also beneficial for reducing or minimizing the amount of olefin saturation, including the amount of saturation from propylene to propane that occurs during deoxygenation. However, the Group VI metal catalysts or Group VIII non-noble metal catalysts, optionally with additional physical promoter metals, are effective for oxygen removal at such hydrogen partial pressures. Depending on the nature of the feed, still lower pressures may be suitable for deoxygenation, such as a total pressure of about 300 psig (2.1 MPag) with a hydrogen partial pressure of about 200 psig (1.4 MPag) or less. Alternatively, higher partial pressures of hydrogen can also be used, such as a hydrogen partial pressure of from about 200 psig (1.4 MPag) to about 2000 psig (14 MPag), such as from about 400 psig (2.8 MPag) to about 1000 psig (6.9 MPag). Higher hydrogen partial pressures can be effective for maintaining a given deoxygenation activity while increasing the throughput of a reactor. However, higher hydrogen partial pressures may reduce the selectivity of the catalyst for performing deoxygenation versus olefin saturation.

The effective conditions for oxygen removal can also include a temperature, a hydrogen rate, and a liquid hourly space velocity (LHSV). Suitable effective temperatures can be from about 230° C. to about 375° C., such as from about 250° C. to about 350° C. The LHSV can be from about 0.1 hr⁻¹ to about 10 hr⁻, such as from about 0.2 hr⁻¹ to about 5.0 hr⁻¹. The hydrogen rate can be any suitable value that provides sufficient hydrogen for deoxygenation of a feedstock. In at least one embodiment, a hydrogen rate can be from about 500 scf/B (84 Nm³/m³) to about 10,000 scf/B (1685 Nm³/m³). One option for selecting a hydrogen rate can be to select a rate based on the expected stoichiometric amount of hydrogen for complete deoxygenation of the feedstock. For example, many types of biocomponent feedstocks have a stoichiometric hydrogen need for deoxygenation of from about 200 scf/B (34 Nm³/m³) to about 1500 scf/B (253 Nm³/m³), depending on the mechanism for oxygen removal. The hydrogen rate can be selected based on a multiple of the stoichiometric hydrogen need, such as at least about 1 times the hydrogen need, or at least about 1.5 times the hydrogen need, or at least about 2 times the hydrogen need.

An additional consideration during deoxygenation is maintaining the sulfided state of the catalyst. If little or no sulfur is present in the reaction environment, the sulfided metal on the catalyst will have a tendency to be reduced and/or converted to oxide form, leading to reduced deoxygenation activity for the catalyst.

To maintain catalyst activity during hydroprocessing a biocomponent feedstock, some sulfur can be introduced into the second hydroprocess reactor. The sulfur can be introduced as sulfur in a mineral feedstock that is blended with the triglyceride-containing biocomponent feed. Additionally or alternatively, sulfur can be introduced, such as by using an H₂ source that contains some H₂5 or introduction of a decomposable liquid sulfur compound such as dimethyl sulfide. The amount of sulfur present in the reaction environment can be at least about 100 wppm, such as at least about 200 wppm or at least about 500 wppm. If this sulfur is introduced as a gas phase component (such as H₂S), the sulfur can be easily removed from a second reactor effluent using a gas-liquid separation, described further below. If the sulfur is introduced as part of the biocomponent feedstock, it may be feasible to blend the resulting products to achieve an acceptable sulfur level in any final product.

The effective conditions for deoxygenation can be suitable for reducing the oxygen content of the biocomponent feedstock to less than about 1.0 wt %, such as less than about 0.5 wt % or less than about 0.2 wt %. Although the stoichiometric hydrogen need is calculated based on complete deoxygenation, reducing the oxygen content to substantially zero is typically not required to allow further processing of the deoxygenated effluent in conventional equipment. Alternatively, in some aspects the effective conditions can be selected to perform at least a partial deoxygenation of the feedstock. A partial deoxygenation corresponds to conditions suitable for reducing the oxygen content of the feedstock by at least about 40%, such as by at least about 50% or at least about 75%.

### Catalysts of the Second Reactor

A catalyst suitable for oxygen removal during processing of a biocomponent feedstock can be a supported metal sulfide catalyst. The metal can be one or more Group VI metals (corresponding to Group 6 of the modern IUPAC periodic table) such as Mo or W, or one or more Group VIII non-noble metals (corresponding to Groups 8-10 of the modern IUPAC periodic table) such as Co. The support for the catalyst can be any convenient type of support, such as alumina, silica, zirconia, titania, amorphous carbon, or combinations thereof. A supported Group VI metal catalyst is a catalyst that includes one or more Group VI metals on a support. A supported Group VI metal catalyst is further defined to exclude the presence of Group VIII metals as part of the catalyst. During catalyst synthesis, the one or more Group VI metals will typically be deposited or otherwise impregnated on the support as oxides. The oxides are typically converted to sulfides prior to use in a deoxygenation process. Thus, a Group VI metal catalyst can include catalysts where the Group VI metal is in either the oxide or the sulfide state on a support. For convenience, a Group VI metal catalyst may also be referred to as a Group VI metal sulfide catalyst, as it is understood by those of skill in the art that the sulfide phase is the active metal phase. A supported Group VIII non-noble metal catalyst can be a catalyst that includes one or more Group VIII non-noble metals on a support. A supported Group VIII non-noble metal catalyst may exclude the presence of Group VI metals as part of the catalyst. A Group VIII non-noble metal catalyst can include catalysts where the Group VIII metal is in either the oxide or the sulfide state on a support. For convenience, a Group VIII non-noble metal catalyst may also be referred to as a Group VIII non-noble metal sulfide catalyst, as it is understood by those of skill in the art that the sulfide phase is the active metal phase. In this document, a supported catalyst that includes both Group VI metals and Group VIII non-noble metals can include both Group VI and Group VIII metals.

Either a Group VI metal catalyst or a Group VIII non-noble metal catalyst may further include another metal as a physical promoter. Examples of metals that act as physical promoters include alkaline earth metals (corresponding to Group 2 of the modern IUPAC periodic table) such as Mg, and Group IIB transition metals (corresponding to Group 12 of the modern IUPAC periodic table) such as Zn. It is noted that both alkaline earth metals and Group IIB transition metals have the feature of no unpaired electrons in the highest occupied s-orbitals or highest occupied (if any) d-orbitals. Physical promoters are in contrast to metals that act as electronic promoters, such as Co or Ni. As noted above, the Group VI metal catalysts may exclude the presence of electronic promoter metals.

The amount of Group VI metal supported on a catalyst support can vary depending on the catalyst. Suitable amounts of metals can be from about 1 wt % to about 30 wt % relative to the total weight of the catalyst. In some embodiments, the amount of Group VI metal supported on the catalyst can be about 20 wt % or less, such as from about 1 wt % to about 15 wt %, such as from about 6 wt % to about 12 wt %. The supported Group VI metal sulfide catalyst can also optionally include dopants and/or other metals different from Group VI or Group VIII transition metals. If the supported metal sulfide catalyst includes a non-noble Group VIII metal instead of a Group VI metal, similar metal loadings on the supported catalyst can be used. If the supported metal catalyst includes a physical promoter metal, the amount of physical promoter metal can be less than the amount of Group VI metal (or Group VIII metal) on the catalyst, such as about 5 wt % or less, or about 3 wt % or less.

Another option is to use a supported Group VI metal catalyst or supported Group VIII non-noble metal catalyst that consists essentially of one or more Group VI metals (or alternatively one or more non-noble Group VIII metals) on a refractory support. Such a catalyst can include a Group VI metal (or a Group VIII metal) on a support such as alumina, silica, titania, zirconia, amorphous carbon or a combination thereof. A catalyst that consists essentially of a Group VI metal (or a non-noble Group VIII metal) on a support does not include more than incidental amounts of dopants, such as phosphorous, fluorine, or boron. A catalyst that consists essentially of a metal on a support also does not include more than incidental amounts of other types of transition metals as catalytic metals, such as Group V metals. However, as noted above, the support may contain transition metal oxides, such as oxides of titanium or zirconium.

Still another option is to use a physically promoted Group VI metal catalyst or a physically promoted Group VIII non-noble metal catalyst that consists essentially of one or more Group VI metals (or alternatively one or more Group VIII non-noble metals) and one or more physical promoter metals on a refractory support. Such a catalyst can include a Group VI metal (or a non-noble Group VIII metal) and a physical promoter metal on a support such as alumina, silica, titania, zirconia, amorphous carbon, or a combination thereof. A catalyst that consists essentially of a Group VI metal (or non-noble Group VIII metal) and a physical promoter metal on a support does not include more than incidental amounts of dopants, such as phosphorous, fluorine, or boron. A catalyst that consists essentially of a Group VI metal (or a non-noble Group VIII metal) and a physical promoter metal on a support also does not include more than incidental amounts of other types of transition metals or transition metal sulfides, such as Group V metal sulfides. However, as noted above, the support may contain transition metal oxides, such as oxides of titanium or zirconium.

Examples of exemplary single metal catalysts include catalysts containing Mo; Co; and W. In such embodiments, the single metal catalyst can be a Mo containing catalyst, or alternatively, a Co containing catalyst, a W containing catalyst, or combination(s) thereof. Examples of physically promoted catalysts can include catalysts containing ZnMo; ZnW; MgMo; MgW; or combination(s) thereof. In such embodiments, the physically promoted catalyst can be a ZnMo containing catalyst, a ZnW containing catalyst, a MgMo containing catalyst, a MgW containing catalyst, or combination(s) thereof.

The supported Group VI metal catalyst or supported Group VIII non-noble metal catalyst can be provided in a reactor in one or more catalyst beds. For example, a convenient bed length in some reactors is a bed length of about 25 feet to 30 feet. Such a bed length reduces difficulties in a catalyst bed associated with poor flow patterns. Due to the low reactivity of some Group VI metal catalysts or Group VIII non-noble metal catalysts, such as sulfided Mo or W catalysts, multiple beds may be for achieving a desired level of deoxygenation.

### Dewaxing

In some embodiments, the hydrotreated product (e.g., reactor effluent) of the first reactor or the second reactor can be dewaxed. For example, a feed of a reactor (such as the second reactor) can be hydrotreated to form a hydrotreated product, and the hydrotreated product can be catalytically dewaxed, either in an integrated unit or a stand-alone unit. The hydrotreatment stage allows for removal of contaminants that may have some effect on the catalytic dewaxing catalysts. In the case of an integrated unit, a stripper may optionally be employed between the hydrotreating and dewaxing stages to remove some byproducts. The hydrotreating stage includes the hydrotreating catalyst, and the dewaxing stage includes the dewaxing catalyst. Dewaxing a hydrotreated product can improve the cold flow properties of the hydrotreated product. Because some types of dewaxing catalysts are sensitive to the presence of oxygen, it may also be desirable to hydrotreat the reactor feed prior to dewaxing. This will typically reduce the olefin content of the feed, but the subsequent dewaxing can offset or even result in a net improvement of the cold flow properties of a diesel product formed from the liquid effluent.

In at least one embodiment, a first reactor effluent includes a hydrotreated product, and a second reactor effluent includes a dewaxed hydrotreated product. In at least one embodiment, a first reactor effluent includes a dewaxed hydrotreated product, and a second reactor effluent includes a dewaxed hydrotreated product.

Suitable dewaxing catalysts can include molecular sieves such as crystalline aluminosilicates (zeolites). In an embodiment, the molecular sieve can include ZSM-5, ZSM-22, ZSM-23, ZSM-35, ZSM-48, zeolite Beta, or a combination thereof, for example ZSM-23 and/or ZSM-48, or ZSM-48 and/or zeolite Beta. Optionally, molecular sieves that are selective for dewaxing by isomerization as opposed to cracking can be used, such as ZSM-48, zeolite Beta, ZSM-23, or a combination thereof. Additionally or alternately, the molecular sieve can include a 10-member ring 1-D molecular sieve. Optionally, the dewaxing catalyst can include a binder for the molecular sieve, such as alumina, titania, silica, silica-alumina, zirconia, or a combination thereof, for example alumina and/or titania or silica and/or zirconia and/or titania.

One characteristic that can impact the activity of the molecular sieve is the ratio of silica to alumina (Si/Al₂ ratio) in the molecular sieve. In an embodiment, the molecular sieve can have a silica to alumina ratio of about 200:1 or less, for example about 150:1 or less, about 120:1 or less, about 100:1 or less, about 90:1 or less, or about 75:1 or less. Additionally or alternately, the molecular sieve can have a silica to alumina ratio of at least about 30:1, for example at least about 40:1, at least about 50:1, or at least about 65:1.

The dewaxing catalyst may include at least one metal hydrogenation component, such as a Group VIII metal. Suitable Group VIII metals can include, but are not limited to, Pt, Pd, Ni, or a combination thereof. When a metal hydrogenation component is present, the dewaxing catalyst can include at least about 0.1 wt % of the Group VIII metal, for example at least about 0.3 wt %, at least about 0.5 wt %, at least about 1.0 wt %, at least about 2.5 wt %, or at least about 5.0 wt %. Additionally or alternately, the dewaxing catalyst can include about 10 wt % or less of the Group VIII metal, for example about 5.0 wt % or less, about 2.5 wt % or less, about 1.5 wt % or less, or about 1.0 wt % or less.

In some embodiments, the dewaxing catalyst can include a Group VIB metal hydrogenation component, such as W and/or Mo. In such embodiments, when a Group VIB metal is present, the dewaxing catalyst can include at least about 0.5 wt % of the Group VIB metal, for example at least about 1.0 wt %, at least about 2.5 wt %, or at least about 5.0 wt %. Additionally or alternately in such embodiments, the dewaxing catalyst can include about 20 wt % or less of the Group VIB metal, for example about 15 wt % or less, about 10 wt % or less, about 5.0 wt % or less, about 2.5 wt % or less, or about 1.0 wt % or less. In one or more embodiments, the dewaxing catalyst can include Pt and/or Pd as the hydrogenation metal component. In another preferred embodiment, the dewaxing catalyst can include as the hydrogenation metal components Ni and W, Ni and Mo, or Ni and a combination of W and Mo.

In various embodiments, the dewaxing catalyst used according to the present disclosure can advantageously be tolerant of the presence of sulfur and/or nitrogen during processing. Suitable catalysts can include those based on zeolites ZSM-48 and/or ZSM-23 and/or zeolite Beta. It is also noted that ZSM-23 with a silica to alumina ratio between about 20:1 and about 40:1 is sometimes referred to as SSZ-32. Additional or alternate suitable catalyst bases can include 1-dimensional 10-member ring zeolites. Further additional or alternate suitable catalysts can include EU-2, EU-11, and/or ZBM-30.

A bound dewaxing catalyst can also be characterized by comparing the micropore (or zeolite) surface area of the catalyst with the total surface area of the catalyst. These surface areas can be calculated based on analysis of nitrogen porosimetry data using the BET method for surface area measurement. Previous work has shown that the amount of zeolite content versus binder content in catalyst can be determined from BET measurements (see, e.g., Johnson, M. F. L., Jour. Catal., (1978) 52, 425). The micropore surface area of a catalyst refers to the amount of catalyst surface area provided due to the molecular sieve and/or the pores in the catalyst in the BET measurements. The total surface area represents the micropore surface plus the external surface area of the bound catalyst. In at least one embodiment, the percentage of micropore surface area relative to the total surface area of a bound catalyst can be at least about 35%, for example at least about 38%, at least about 40%, or at least about 45%. Additionally or alternately, the percentage of micropore surface area relative to total surface area can be about 65% or less, for example about 60% or less, about 55% or less, or about 50% or less.

Catalytic dewaxing can be performed by exposing a feedstock to a dewaxing catalyst under effective (catalytic) dewaxing conditions. Effective dewaxing conditions can include temperatures of about 550° F. (288° C.) to about 840° F. (449° C.), hydrogen partial pressures of from about 250 psig to about 5000 psig (1.8 MPag to 34.6 MPag), and hydrogen treat gas rates of from 35.6 sm³/m³ to 1781 sm³/m³ (200 SCF/B to 10,000 SCF/B). In other embodiments, the conditions can include temperatures in the range of about 600° F. (343° C.) to about 815° F. (435° C.), hydrogen partial pressures of from about 500 psig to about 3000 psig (3.5 MPag-20.9 MPag), and hydrogen treat gas rates of from about 213 sm³/m³ to about 1068 sm³/m³ (1200 SCF/B to 6000 SCF/B). The liquid hourly space velocity (LHSV) of the feed relative to the dewaxing catalyst can be characterized can be from about 0.1 hr⁻¹ to about 10 hr⁻⁰.

### Properties of Second Reactor Effluent

A second reactor effluent (that has been catalytically dewaxed) can have an oxygen content of about 1 wt % or less, based on the total weight of the second reactor effluent, such as an oxygen content of from about 0.001 wt % to about 13 wt %, such as from about 0.001 wt % to about 7.5 wt %, such as from about 0.001 wt % to about 5 wt %, such as from about 0.001 wt % to about 2.5 wt %, such as from about 0.001 wt % to about 1 wt %, such as from about 0.001 wt % to about 0.5 wt %.

### Separation of Fuel Product from Gas Phase Components

The first reactor effluent and the second reactor effluent are mixed to form a mixture that is introduced to a separation unit to form a fuel product. A separation unit can be any suitable separation unit, such as a gas-liquid separation unit.

After performing a deoxygenation under effective conditions in the presence of a Group VI metal catalyst or Group VIII non-noble metal catalyst, gas phase components can also include, but are not limited to, deoxygenation reaction products such as H₂O, CO₂, and/or CO; gases present in the reaction environment, such as H₂, H₂S, N₂, and/or other inert gases; potential light ends cracking products from the deoxygenation reaction; and propane, which is the expected typical product generated from a glycerol backbone of a triglyceride during a deoxygenation reaction (if triglycerides are present in a feed).

In a conventional hydroprocess reactor of mineral hydrocarbon feedstocks, a small amount of water is present, and a reactor effluent is provided to a separation drum in a separation unit that is configured to separate water. It has been discovered that conventional separators for separating hydroprocessed mineral hydrocarbon feedstocks can be used to remove water from the mixture of first reactor effluent (hydroprocessed mineral hydrocarbon feedstock) and second reactor effluent (hydroprocessed biocomponent feedstock). For example, hydrotreating the biocomponent feedstock creates water, but the usual separation apparatus for hydroprocessed mineral hydrocarbon feedstocks can be used for separating water from hydroprocessed mineral hydrocarbon feedstocks, for example, containing 10% water. Accordingly, in at least one embodiment, a conventional separator is used and a fuel product comprising about 50 vol% or less of biofuel content is obtained, such that there is not too much water present for a conventional separation unit to separate from the fuel product in the separation unit.

In at least one embodiment, a separation drum has a gas outlet (toward the top of the drum), a hydrocarbon outlet (toward the bottom of the drum), and a water outlet (toward the bottom of the drum).

The gas phase products can be separated from the liquid products from the mixture, which will typically be diesel boiling range and/or naphtha boiling range molecules.

Any convenient method for providing a distillation column with a sufficient number of equivalent trays can be used.

### Fuel Products

A fuel product of the present disclosure can be any suitable fuel product, such as a diesel range product. A fuel product of the present disclosure can include a biofuel content. The biofuel content can be the diesel range product(s) formed from hydroprocessing (and optionally dewaxing) the biocomponent feedstock, e.g., hydroprocessing and dewaxing performed in the second reactor.

In at least one embodiment, a fuel product of the present disclosure has a biocontent of about 1 vol % or greater, such as from about 1 vol % to about 50 vol %, such as from about 5 vol % to about 45 vol %, such as from about 10 vol % to about 45 vol %, such as from about 15 vol % to about 45 vol %, such as from about 20 vol % to about 45 vol %, such as from about 25 vol % to about 45 vol %, such as from about 30 vol % to about 40%, alternatively from about 5 vol % to about 20 vol %, such as from about 5 vol % to about 15 vol %, such as from about 10 vol % to about 15 vol %, based on the volume of the fuel product. Methods and apparatus of the present disclosure can provide significantly higher amounts of biofuel content present in a diesel mixture, as compared to conventional methods and apparatus that coprocess mixtures of biocomponent feedstock and mineral hydrocarbon feedstock.

Generally, diesel engines operate well with a cetane number of from 48 to 80, such as from 51 to 60. Fuels with a lower cetane number have longer ignition delays, and involve more time for the fuel combustion process to be completed. Hence, higher speed diesel engines operate more effectively with higher cetane number fuels. A fuel product of the present disclosure can be useful as a diesel fuel, as indicated by advantageous cetane numbers. For example, a fuel product can have a cetane number of about 30 or greater, such as about 40 or greater, such as about 45 or greater, such as about 48 or greater, such as about 50 or greater, such as about 60 or greater, such as about 70 or greater, such as about 80 or greater, such as about 90 or greater, such as from about 30 to about 120, such as from about 50 to about 120, such as from about 70 to about 120, such as from about 90 to about 110.

A fuel product can have a sulfur content of from 0 wppm to about 5,000 wppm, based on the total weight of the fuel product, such as from 0 wppm to about 2,000 wppm, such as from 10 wppm to about 200 wppm.

Advantageously, due its low sulfur content, the fuel product may be suitable as an ULSFO and/or a LSFO. The fuel product can also be used to extend the ULSFO pool and/or LSFO pool, which may permit the blending of LSFO with a ULSFO, blending of RSFO with a LSFO, and/or blending of a more viscous blendstock material with a LSFO or an ULSFO.

A fuel product can have a nitrogen content of about 1 wt % or less, based on the total weight of the fuel product, such as a nitrogen content of from about 0.001 wt % to about 1 wt %, such as from about 0.001 wt % to about 0.9 wt %, such as from about 0.001 wt % to about 0.6 wt %, such as from about 0.001 wt % to about 0.5 wt %, such as from about 0.001 wt % to about 0.2 wt %, such as from about 0.001 wt % to about 0.1 wt %.

A fuel product can have an oxygen content of about 1 wt % or less, based on the total weight of the fuel product, such as an oxygen content of from about 0.001 wt % to about 1 wt %, such as from about 0.001 wt % to about 0.9 wt %, such as from about 0.001 wt % to about 0.7 wt %, such as from about 0.001 wt % to about 0.5 wt %, such as from about 0.001 wt % to about 0.3 wt %, such as from about 0.001 wt % to about 0.1 wt %.

Additionally or alternatively, the fuel product may have a paraffin content. For example, the fuel product may have a paraffin content, based on total weight of the fuel product, of ≥about 50 wt %, ≥about 70 wt %, ≥about 80 wt %, ≥about ≥85 wt %, ≥about 90 wt %, ≥about 95 wt %, or ≥about 99 wt %. Additionally or alternatively, the fuel product may have a paraffin content, based on total weight of the fuel product, of about 50 wt % to about 100 wt %, about 70 wt % to about 99.9 wt %, about 85 wt % to about 99 wt %, or about 95 wt % to about 99 wt %.

Additionally or alternatively, the fuel product may have a suitable asphaltenes content, which also may increase its compatibility with various residual fuel oils.

For example, the fuel product may have an asphaltenes content, based on total weight of the fuel product, of ≤about 20 wt %, ≤about 15 wt %, ≤about 10 wt %, ≤about 5 wt %, ≤about 3 wt %, ≤about 2 wt %, ≤about 1 wt %, or ≤about 0.5 wt %. Additionally or alternatively, the fuel product may have an asphaltenes content, based on total weight of the fuel product, of about 0.01 wt % to about 10 wt %, about 0.1 wt % to about 5 wt %, about 0.5 wt % to about 3 wt %, or about 0.5 wt % to about 1.5 wt %.

### Fuel Blends

Fuel products of the present disclosure may be used as fuel, such as diesel fuel, or may be further mixed to form any suitable composition. For example, a fuel product can be used as a fuel oil blendstock and may be blended with various fuel streams to produce any suitable fuel blend. Thus, a fuel blend comprising (i) the fuel product and (ii) a fuel stream is provided herein.

Any suitable fuel stream may be used. Non-limiting examples of suitable fuel streams include a low sulfur diesel, an ultra low sulfur diesel, a low sulfur gas oil, an ultra low sulfur gas oil, a low sulfur kerosene, an ultra low sulfur kerosene, a hydrotreated straight run diesel, a hydrotreated straight run gas oil, a hydrotreated straight run kerosene, a hydrotreated cycle oil, a hydrotreated thermally cracked diesel, a hydrotreated thermally cracked gas oil, a hydrotreated thermally cracked kerosene, a hydrotreated coker diesel, a hydrotreated coker gas oil, a hydrotreated coker kerosene, a hydrocracker diesel, a hydrocracker gas oil, a hydrocracker kerosene, a gas-to-liquid diesel, a gas-to-liquid kerosene, a hydrotreated vegetable oil, a fatty acid methyl esters, a non-hydrotreated straight-run diesel, a non-hydrotreated straight-run kerosene, a non-hydrotreated straight-run gas oil, a distillate derived from low sulfur crude slates, a gas-to-liquid wax, gas-to-liquid hydrocarbons, a non-hydrotreated cycle oil, a non-hydrotreated fluid catalytic cracking slurry oil, a non-hydrotreated pyrolysis gas oil, a non-hydrotreated cracked light gas oil, a non-hydrotreated cracked heavy gas oil, a non-hydrotreated pyrolysis light gas oil, a non-hydrotreated pyrolysis heavy gas oil, a non-hydrotreated thermally cracked residue, a non-hydrotreated thermally cracked heavy distillate, a non-hydrotreated coker heavy distillates, a non-hydrotreated vacuum gas oil, a non-hydrotreated coker diesel, a non-hydrotreated coker gasoil, a non-hydrotreated coker vacuum gas oil, a non-hydrotreated thermally cracked vacuum gas oil, a non-hydrotreated thermally cracked diesel, a non-hydrotreated thermally cracked gas oil, a Group 1 slack wax, a lube oil aromatic extracts, a deasphalted oil, an atmospheric tower bottoms, a vacuum tower bottoms, a steam cracker tar, a residue material derived from low sulfur crude slates, an ultra low sulfur fuel oil (ULSFO), a low sulfur fuel oil (LSFO), regular sulfur fuel oil (RSFO), marine fuel oil, a hydrotreated residue material (e.g., residues from crude distillation), a hydrotreated fluid catalytic cracking slurry oil, and a combination thereof. In particular, the fuel stream may be a hydrotreated gas oil, a LSFO, a ULSFO and/or a marine fuel oil.

In various aspects, the fuel product may be present in the fuel blend in an amount of about 40 wt % to about 70 wt % or about 50 wt % to about 60 wt %. Additionally, the fuel stream may be present in the fuel blend in an amount of about 30 wt % to about 60 wt % or about 40 wt % to about 50 wt %.

Advantageously, a fuel blend described herein may have a low sulfur content, a low pour point, a low viscosity and desirable energy content. In various aspects, the fuel blend may have a sulfur content of, based on total weight of the fuel blend, of ≤about 5.0 wt %, ≤about 2.5 wt %, ≤about 1.0 wt %, ≤about 0.75 wt %, ≤about 0.50 wt %, ≤about 0.40 wt %, ≤about 0.30 wt %, ≤about 0.20 wt %, ≤about 0.10 wt % or about 0.050 wt %. For example, the fuel blend may have a sulfur content, based on total weight of the fuel blend, of about 0.050 wt % to about 5.0 wt %, about 0.050 wt % to about 1.0 wt %, about 0.050 wt % to about 0.50 wt %, or about 0.050 wt % to about 0.10 wt %. For example, the fuel blend may have a sulfur content, based on total weight of the fuel blend, of ≤about 0.50 wt %.

### Examples of Processing Configurations

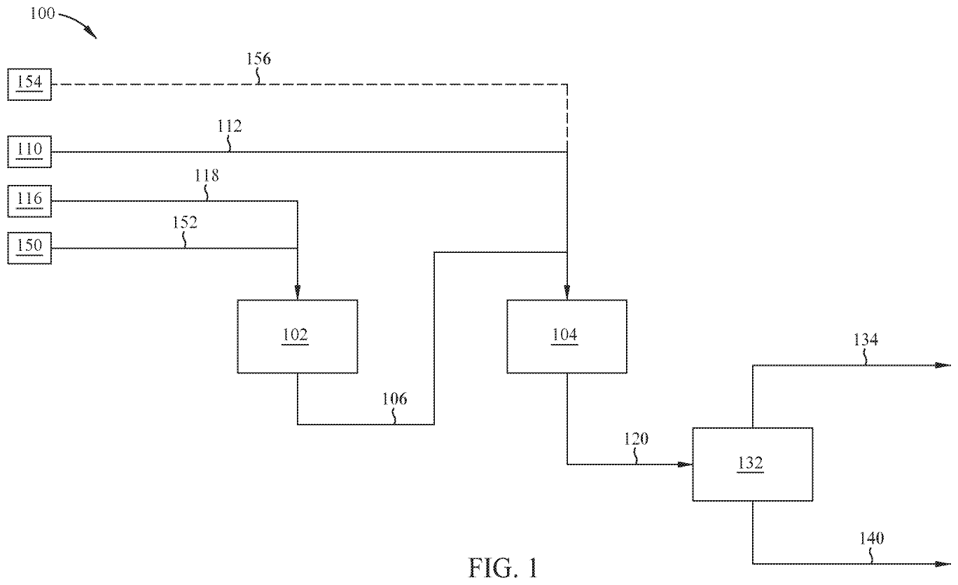

FIG. 1 is an apparatus 100 configured to form fuel products, according to at least one embodiment. Apparatus 100 has a first reactor 102 and a second reactor 104. Apparatus 100 is configured such that first reactor 102 and second reactor 104 can be operated in a “partial-parallel, partial-series” configuration. First reactor 102 is configured to hydroprocess a mineral hydrocarbon feedstock. Mineral hydrocarbon feedstock can be introduced to first reactor 102 from mineral hydrocarbon feedstock source 116 via line 118. A treat gas (e.g., hydrogen) is introduced to first reactor 102 from treat gas source 150 via line 152. A first reactor effluent is transferred from first reactor 102 to second reactor 104 via line 106. For example, a portion or all of the first reactor effluent is transferred via line 106 and is introduced to second reactor 104, providing a “partial-series” configuration of first reactor 102 and second reactor 104.

A biocomponent feedstock source 110 provides a biocomponent feedstock to second reactor 104 via line 112, providing a “partial-parallel” configuration of first reactor 102 and second reactor 104. An optional treat gas (e.g., hydrogen) may be introduced to second reactor 102 from second treat gas source 154 via line 156. Second reactor 104 is configured to hydroprocess the biocomponent feedstock and/or the first reactor effluent (and dewax the hydroprocessed product). A second reactor effluent is transferred via line 120. All or a portion of the mixture can be (1) recycled to first reactor 102 via a line (not shown) for additional hydroprocessing or in series hydroprocessing, e.g., as described above, (2) recycled to second reactor 104 via a line (not shown) for additional hydroprocessing, or (3) transferred to a furnace 124 (such as a steam cracker) via a line (not shown) for additional treatment of heavy components (if any) in the mixture. The mixture transferred for additional treatment of heavy components is optionally heated by a heat exchanger before introducing the mixture to furnace 124. A reactor furnace can produce a heated mixture of first reactor effluent and second reactor effluent. All or a portion of the heated mixture is (1) introduced to first reactor 102 via a line (not shown) for additional hydroprocessing or in series hydroprocessing, e.g., as described above.

Additionally or alternatively, all or a portion of the mixture of first reactor effluent and second reactor effluent (which optionally contains the pyrolyzed mixture described above) is introduced to first separation unit 132. First separation unit 132 can be a gas-liquid separation unit. First separation unit 132 can be configured to separate light products from a fuel product and remove the light products via line 134. The light products can be sent away via line 134 or can be sent for further processing to a second separation unit (not shown). The fuel product of first separation unit 132 is removed from first separation unit 132 via line 140 and is sent away via line 140 or can be sent for further processing via a line to a third separation unit (not shown).

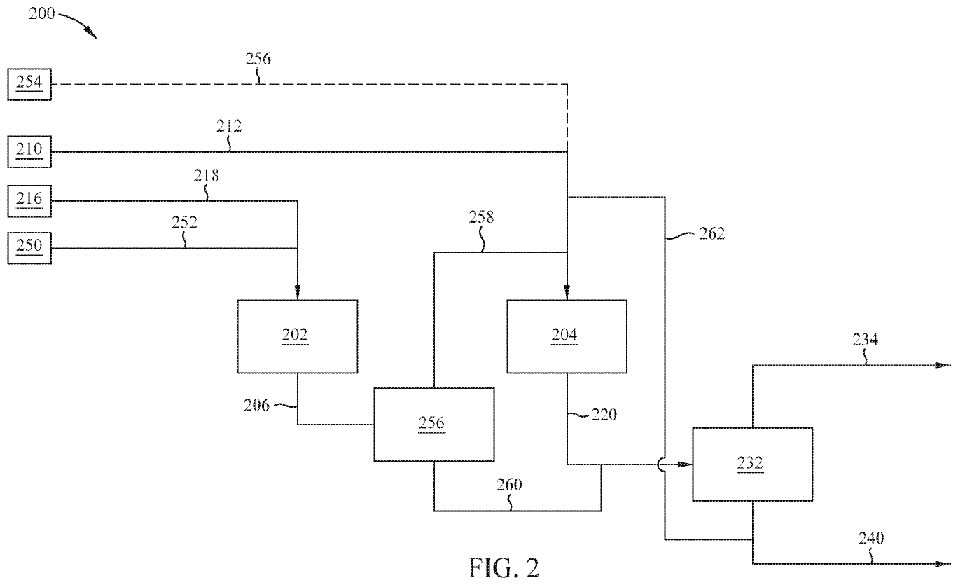

FIG. 2 is an apparatus 200 configured to form fuel products, according to at least one embodiment. Apparatus 200 has a first reactor 202 and a second reactor 204. Apparatus 200 is configured such that first reactor 202 and second reactor 204 can be operated in a “partial-parallel, partial-series” configuration. First reactor 202 is configured to hydroprocess a mineral hydrocarbon feedstock. Mineral hydrocarbon feedstock can be introduced to first reactor 202 from mineral hydrocarbon feedstock source 216 via line 218. A treat gas (e.g., hydrogen) is introduced to first reactor 202 from treat gas source 250 via line 252. A first reactor effluent is transferred from first reactor 202 for further processing via line 206.

A first reactor effluent is transferred via line 206 and all or a portion of the first reactor effluent is introduced to a separation unit. For example, all or a portion of the first reactor effluent is transferred to a separation unit 256. Separation unit 256 can be a gas-liquid separation unit for removing gas products from the first reactor effluent (as a separation unit effluent). Thereafter, the separation unit effluent is introduced to second reactor 204 via line 258 to second reactor 204 for further hydroprocessing.

A biocomponent feedstock source 210 provides a biocomponent feedstock to second reactor 204 via line 212, providing a “partial-parallel” configuration of first reactor 202 and second reactor 204. The biocomponent feedstock can be heated with a heat exchanger (not shown) that is coupled with line 212. An optional treat gas (e.g., hydrogen) is introduced to second reactor 202 from treat gas source 254 via line 256. Second reactor 204 is configured to hydroprocess the biocomponent feedstock (and dewax the hydroprocessed product).

A bottoms effluent from separation unit 256 is transferred via line 260 to line 220 to mix with a second reactor effluent of line 220.

All or a portion of the mixture of line 220 can be (1) recycled to first reactor 202 via a line not shown for additional hydroprocessing or in series hydroprocessing, e.g., as described above, (2) recycled to second reactor 204 via a line (not shown) for additional hydroprocessing, or (3) transferred to a furnace (not shown) via line a line (not shown) for additional treatment of heavy components (if any) in the mixture. The mixture transferred via line 220 is optionally heated by a heat exchanger (not shown) before introducing the mixture to the furnace. The furnace can produce a heated mixture of first reactor effluent and second reactor effluent. All or a portion of the heated mixture is (1) introduced to first reactor 202 via a line (not shown) for additional hydroprocessing or in series hydroprocessing, e.g., as described above, or (2) introduced to line 220 via a line (not shown) to be mixed with the mixture of first reactor effluent and second reactor effluent of line 220.

Additionally or alternatively, all or a portion of the mixture of first reactor effluent and second reactor effluent (which optionally contains the heated mixture described above) is introduced to first separation unit 232. First separation unit 232 can be a gas-liquid separation unit. First separation unit 232 can be configured to separate light products from a fuel product and remove the light products via line 234. The light products can be sent away via line 234 or can be sent for further processing to a second separation unit (not shown). The fuel product of first separation unit 232 is removed from first separation unit 232 via line 240 and all or a portion of the fuel product is (1) sent away via line 240, (2) recycled via a line 262 to second reactor 204 or via a line (not shown) to first reactor 202, or (3) sent for further processing via line 240 to a third separation unit (not shown).

### Embodiments Listing

The present disclosure provides, among others, the following embodiments, each of which may be considered as optionally including any alternate embodiments.

Clause 1. A process comprising:

hydroprocessing a mineral hydrocarbon feedstock in the presence of a first catalyst in a first reactor, and removing a first reactor effluent from the first reactor;

hydroprocessing a biocomponent feedstock in the presence of a second catalyst in a second reactor, and removing a second reactor effluent from the second reactor;

mixing at least a portion of the first reactor effluent with at least a portion of the second reactor effluent to form a mixture; and

introducing the mixture to a separation unit to form a fuel product.

Clause 2. A process comprising:

hydroprocessing a mineral hydrocarbon feedstock in the presence of a first catalyst in a first reactor, and removing a first reactor effluent from the first reactor;

introducing the first reactor effluent to a second reactor;

hydroprocessing a biocomponent feedstock and the first reactor effluent in the presence of a second catalyst in the second reactor, and removing a second reactor effluent from the second reactor; and

introducing the second reactor effluent to a separation unit to form a fuel product.

Clause 3. The process of Clause 1 or Clause 2, wherein hydroprocessing the biocomponent feedstock forms a hydroprocessed product, the process further comprising:

dewaxing the hydroprocessed product in the second reactor to form a dewaxed hydroprocessed product, wherein the second reactor effluent comprises the dewaxed hydroprocessed product.

Clause 4. The process of any of Clauses 1 to 3, further comprising introducing at least a portion of the first reactor effluent to the second reactor and hydroprocessing the at least a portion of the first reactor effluent in the presence of the second catalyst in the second reactor, wherein the second reactor effluent comprises hydroprocessed biocomponent feedstock and hydroprocessed first reactor effluent.
Clause 5. The process of any of Clauses 1 to 4, further comprising:

introducing at least a portion of the first reactor effluent to a separation unit to form a separation unit effluent comprising hydrogen; and

introducing the separation unit effluent to the second reactor.

Clause 6. The process of any of Clauses 1 to 5, further comprising introducing the fuel product to the second reactor and hydroprocessing the fuel product in the presence of the second catalyst.
Clause 7. The process of any of Clauses 1 to 6, wherein the mineral hydrocarbon feedstock is selected from the group consisting of a virgin distillate, a hydrotreated virgin distillate, kerosene, a diesel boiling range feed, a light cycle oil, an atmospheric gasoil, and combination(s) thereof.
Clause 8. The process of any of Clauses 1 to 7, wherein hydroprocessing the mineral hydrocarbon feedstock comprises introducing the mineral hydrocarbon feedstock to the first reactor at a liquid hourly space velocity of from about 1 h⁻¹ to about 8 h⁻¹.
Clause 9. The process of any of Clauses 1 to 8, wherein hydroprocessing the mineral hydrocarbon feedstock is performed at a temperature of from about 275° C. (527° F.) to about 350° C. (662° F.).
Clause 10. The process of any of Clauses 1 to 9, wherein hydroprocessing the mineral hydrocarbon feedstock is performed at a pressure of from about 300 psig to about 500 psig.
Clause 11. The process of any of Clauses 1 to 10, wherein hydroprocessing the mineral hydrocarbon feedstock comprises introducing hydrogen to the first reactor at a pressure of from about 300 psig to about 500 psig.
Clause 12. The process of any of Clauses 1 to 11, wherein the first catalyst is selected from the group consisting of vanadium, chromium, molybdenum, tungsten, manganese, technetium, rhenium, iron, cobalt, nickel, ruthenium, palladium, rhodium, osmium, iridium, platinum, and mixture(s) thereof.
Clause 13. The process of any of Clauses 1 to 12, wherein the first reactor effluent has a sulfur content from about 10 wppm to about 200 wppm and a nitrogen content of about 100 ppm or less, based on the total weight of the first reactor effluent.
Clause 14. The process of any of Clauses 1 to 13, wherein the biocomponent feedstock comprises triglycerides and fatty acids.
Clause 15. The process of any of Clauses 1 to 14, wherein the biocomponent feedstock comprises fatty acid esters.
Clause 16. The process of any of Clauses 1 to 15, wherein hydroprocessing the biocomponent feedstock is performed at a temperature of from about 250° C. to about 350° C.
Clause 17. The process of any of Clauses 1 to 16, wherein hydroprocessing the biocomponent feedstock is performed at a liquid hourly space velocity of from about 0.2 hr⁻¹ to about 5.0 hr⁻¹.
Clause 18. The process of any of Clauses 1 to 17, wherein the second catalyst is selected from the group consisting of molybdenum, tungsten, cobalt, nickel, and mixture(s) thereof.
Clause 19. The process of any of Clauses 1 to 18, wherein the second reactor effluent has an oxygen content of from about 0.001 wt % to about 1 wt %, based on the total weight of the second reactor effluent.
Clause 20. The process of any of Clauses 1 to 19, wherein hydroprocessing the mineral hydrocarbon feedstock forms a hydroprocessed product, the process further comprising:

dewaxing the hydroprocessed product in the first reactor to form a dewaxed hydroprocessed product, wherein the first reactor effluent comprises the dewaxed hydroprocessed product.

Clause 21. The process of any of Clause 1 to 20, wherein the dewaxing is performed by introducing the hydroprocessed product to a dewaxing catalyst under dewaxing conditions, wherein the dewaxing conditions comprise:

a temperature of from about 288° C. to about 449° C.,

a hydrogen partial pressure of from about 250 psig to about 5000 psig ,

a hydrogen treat gas rate of from about 35.6 sm³/m³ to about 1781 sm³/m³; and

a liquid hourly space velocity (LHSV) of the feed to the reactor (first reactor or second reactor) relative to the dewaxing catalyst of from about 0.1 hr⁻¹ to about 10 hr⁻¹.

Clause 22. The process of any of Clauses 1 to 21, wherein the separation unit comprises a gas-liquid separator.
Clause 23. The process of any of Clauses 1 to 22, wherein the fuel product has a biofuel content of from about 5 vol % to about 45 vol %, based on the volume of the fuel product.
Clause 24. The process of any of Clauses 1 to 20, wherein the fuel product has a biofuel content of from about 10 vol % to about 15 vol %, based on the volume of the fuel product.
Clause 25. The process of any of Clauses 1 to 24, wherein the fuel product has a cetane number of from about 70 to about 120.
Clause 26. The process of any of Clauses 1 to 25, wherein the fuel product has a cetane number of from about 90 to about 120.
Clause 27. The process of any of Clauses 1 to 26, wherein the fuel product has a sulfur content of from 0 wppm to about 2,000 wppm, based on the total weight of the fuel product.
Clause 28. The process of any of Clauses 1 to 27, wherein the fuel product has a nitrogen content of from about 0.001 wt % to about 0.5 wt %, based on the total weight of the fuel product.
Clause 29. The process of any of Clauses 1 to 28, wherein the fuel product has an oxygen content of from about 0.001 wt % to about 0.01 wt %, based on the total weight of the fuel product.
Clause 30. An apparatus comprising:

a first hydroprocess reactor;

a second hydroprocess reactor coupled with the first hydroprocess reactor; and

a separation unit coupled with the second hydroprocess reactor.

Clause 31. The apparatus of Clause 30, further comprising:

a mineral hydrocarbon feedstock source coupled with the first reactor; and

a biocomponent feedstock source coupled with the second reactor.

Clause 32. The apparatus of Clause 30 or 31, wherein the separation unit comprises a gas-liquid separator.
Clause 33. The apparatus of any of Clauses 30 to 32, further comprising a treat gas source coupled with the first reactor, wherein the apparatus is free of a treat gas source coupled with the second reactor.
Clause 34. An apparatus comprising:

a first hydroprocess reactor;

a second hydroprocess reactor;

a first separation unit coupled with and disposed between the first hydroprocess reactor and the second hydroprocess reactor; and

a second separation unit coupled with the first hydroprocess reactor and the second hydroprocess reactor.

Clause 35. The apparatus of Clause 34, further comprising:

a mineral hydrocarbon feedstock source coupled with the first reactor; and

a biocomponent feedstock source coupled with the second reactor.

Clause 36. The apparatus of Clause 34 or 35, wherein the first separation unit comprises a gas-liquid separator, and the second separation unit comprises a gas-liquid separator.
Clause 37. The apparatus of any of Clauses 34 to 36, further comprising:

a third separation unit coupled with the second separation unit; and

a fourth separation unit coupled with the second separation unit and the third separation unit.

Clause 38. The apparatus of any of Clauses 34 to 37, wherein:

the second separation unit is coupled with the second hydroprocess reactor via a first line, and

the second separation unit is coupled with the second hydroprocess reactor via a second line.

Clause 39. A process of any of Clauses 1 to 38, wherein the process comprises:

hydroprocessing a mineral hydrocarbon feedstock in the presence of a first catalyst in a first reactor, and removing a first reactor effluent from the first reactor;

introducing at least a portion of the first reactor effluent to a separation unit to form a first separation unit effluent comprising hydrogen and a second separation unit effluent comprising a first hydroprocessed product;

introducing the first separation unit effluent to a second reactor;

hydroprocessing a biocomponent feedstock in the presence of a second catalyst in the second reactor to form a second hydroprocessed product;

dewaxing the second hydroprocessed product in the second reactor to form a dewaxed hydroprocessed product;

removing a second reactor effluent comprising the dewaxed hydroprocessed product from the second reactor;

mixing at least a portion of the first reactor effluent with at least a portion of the second reactor effluent to form a mixture; and

introducing the mixture to a separation unit to form a fuel product.

Clause 40. The process of Clause 39, further comprising introducing the fuel product to the second reactor and hydroprocessing the fuel product in the presence of the second catalyst.

Overall, the present disclosure provides processes and apparatus that can provide a separate hydroprocess reactor for a biocomponent feedstock (which has low amounts of sulfur or is free of sulfur), and a lower temperature for hydroprocessing can be used (e.g., 450° F.-500° F.) (as compared to coprocessing). An exothermic heat release during hydroprocessing and effluent removal from the reactor can be tolerated, e.g. without affecting the metallurgical properties of the outlet of the reactor. In embodiments where a mineral hydrocarbon feedstock is hydroprocessed in a first reactor upstream of a second reactor (e.g., in series) that hydroprocesses a biocomponent feedstock, hydrogen content present in the first reactor effluent can be introduced along with the first reactor effluent to the second reactor. Accordingly, hydrogen from an external source need not be introduced to the second reactor (or a lesser amount of hydrogen from an external source can be introduced to the second reactor as compared to conventional hydroprocessing of biocomponent feedstocks), which provides a more environmentally friendly process as compared to, for example, processes where excess hydrogen is burned off. It has been further discovered that the effluent from the first reactor and the second reactor can be mixed and introduced to a separator (such as a liquid-vapor separator) such that, for example, water can be removed from the mixture.

Processes and apparatus of the present disclosure can provide fuel products having increased biofuel content, as compared to fuel products formed by, for example, coprocessing. Processes and apparatus of the present disclosure can provide increased energy efficiency, reduced fuel production cost, and improved hydrogen management as compared to conventional processes and apparatus.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A process comprising:
hydroprocessing a mineral hydrocarbon feedstock in the presence of a first catalyst in a first reactor, and removing a first reactor effluent from the first reactor;
hydroprocessing a biocomponent feedstock in the presence of a second catalyst in a second reactor, and removing a second reactor effluent from the second reactor;
mixing at least a portion of the first reactor effluent with at least a portion of the second reactor effluent to form a mixture; and
introducing the mixture to a separation unit to form a fuel product.

2. (canceled)

3. The process of claim 1, wherein hydroprocessing the biocomponent feedstock forms a hydroprocessed product, the process further comprising:
dewaxing the hydroprocessed product in the second reactor to form a dewaxed hydroprocessed product, wherein the second reactor effluent comprises the dewaxed hydroprocessed product.

4. The process of claim 1, further comprising introducing at least a portion of the first reactor effluent to the second reactor and hydroprocessing the at least a portion of the first reactor effluent in the presence of the second catalyst in the second reactor, wherein the second reactor effluent comprises hydroprocessed biocomponent feedstock and hydroprocessed first reactor effluent.

5. The process of claim 1, further comprising:
introducing at least a portion of the first reactor effluent to a separation unit to form a separation unit effluent comprising hydrogen; and
introducing the separation unit effluent to the second reactor.

6. The process of claim 1, further comprising introducing the fuel product to the second reactor and hydroprocessing the fuel product in the presence of the second catalyst.

7. The process of claim 1, wherein the mineral hydrocarbon feedstock is selected from the group consisting of a virgin distillate, a hydrotreated virgin distillate, kerosene, a diesel boiling range feed, a light cycle oil, an atmospheric gasoil, and combination(s) thereof.

8. The process of claim 1, wherein hydroprocessing the mineral hydrocarbon feedstock comprises introducing the mineral hydrocarbon feedstock to the first reactor at a liquid hourly space velocity of from about 1 h−1 to about 8 h−1.

9.-11. (canceled)

12. The process of claim 1, wherein the first catalyst is selected from the group consisting of vanadium, chromium, molybdenum, tungsten, manganese, technetium, rhenium, iron, cobalt, nickel, ruthenium, palladium, rhodium, osmium, iridium, platinum, and mixture(s) thereof.

13. The process of claim 1, wherein the first reactor effluent has a sulfur content from about 10 wppm to about 200 wppm and a nitrogen content of about 100 ppm or less, based on the total weight of the first reactor effluent.

14.-15. (canceled)

16. The process of claim 1, wherein hydroprocessing the biocomponent feedstock is performed at a temperature of from about 250° C. to about 350° C.

17. The process of claim 1, wherein hydroprocessing the biocomponent feedstock is performed at a liquid hourly space velocity of from about 0.2 hr−1 to about 5.0 hr−1.

18. The process of claim 1, wherein the second catalyst is selected from the group consisting of molybdenum, tungsten, cobalt, nickel, and mixture(s) thereof

19. The process of claim wherein the second reactor effluent has an oxygen content of from about 0.001 wt % to about 1 wt %, based on the total weight of the second reactor effluent.

20. The process of claim 1, wherein hydroprocessing the mineral hydrocarbon feedstock forms a hydroprocessed product, the process further comprising:
dewaxing the hydroprocessed product in the first reactor to form a dewaxed hydroprocessed product, wherein the first reactor effluent comprises the dewaxed hydroprocessed product.

21. The process of claim 1, wherein hydroprocessing the biocomponent feedstock forms a hydroprocessed product, the process further comprising introducing the hydroprocessed product to a dewaxing catalyst under dewaxing conditions, wherein the dewaxing conditions comprise:
a temperature of from about 288° C. to about 449° C.,
a hydrogen partial pressure of from about 250 psig to about 5000 psig;
a hydrogen treat gas rate of from about 35.6 sm3/m3 to about 1781 sm3/m3; and
a liquid hourly space velocity (LHSV) of the feed to the second reactor relative to the dewaxing catalyst of from about 0.1 hr−1 to about 10 hr−1.

22. The process of claim 1, wherein hydroprocessing the biocomponent feedstock forms a hydroprocessed product, the process further comprising introducing the hydroprocessed product to a dewaxing catalyst under dewaxing conditions, wherein the dewaxing conditions comprise:
a temperature of from about 288° C. to about 449° C.,
a hydrogen partial pressure of from about 250 psig to about 5000 psig;
a hydrogen treat gas rate of from about 35.6 sm3/m3 to about 1781 sm3/m3; and
a liquid hourly space velocity (LHSV) of the feed to the first reactor relative to the dewaxing catalyst of from about 0.1 hr−1 to about 10 hr−1.

23.-26. (canceled)

27. The process of claim 1, wherein the fuel product has a cetane number of from about 90 to about 120.

28. The process of claim 1, wherein the fuel product has a sulfur content of from 0 wppm to about 2,000 wppm, based on the total weight of the fuel product.

29. The process of claim 1 wherein the fuel product has a nitrogen content of from about 0.001 wt % to about 0.5 wt %, based on the total weight of the fuel product.

30. The process of claim 1, wherein the fuel product has an oxygen content of from about 0.001 wt % to about 0.1 wt %, based on the total weight of the fuel product.

31.-39. (canceled)

40. A process comprising:
hydroprocessing a mineral hydrocarbon feedstock in the presence of a first catalyst in a first reactor, and removing a first reactor effluent from the first reactor;
introducing at least a portion of the first reactor effluent to a separation unit to form a first separation unit effluent comprising hydrogen and a second separation unit effluent comprising a first hydroprocessed product;
introducing the first separation unit effluent to a second reactor;
hydroprocessing a biocomponent feedstock in the presence of a second catalyst in the second reactor to form a second hydroprocessed product;
dewaxing the second hydroprocessed product in the second reactor to form a dewaxed hydroprocessed product;
removing a second reactor effluent comprising the dewaxed hydroprocessed product from the second reactor;
mixing the first reactor effluent with the second reactor effluent to form a mixture; and
introducing the mixture to a separation unit to form a fuel product.

41. The process of claim 40, further comprising introducing the fuel product to the second reactor and hydroprocessing the fuel product in the presence of the second catalyst.
